(19) United States
(12) Patent Application Publication
(10) Pub. No.: US 2007/0028606 A1
(43) Pub. Date: Feb. 8, 2007

(54) Power steering device

(75) Inventors: Masaki Misunou, Kanagawa (JP); Masakazu Kurata, Yokohama (JP); Mitsuo Sasaki, Kanagawa (JP); Masaaki Busujima, Kanagawa (JP); Yoshimori Kondo, Kanagawa (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/493,895

(22) Filed: Jul. 27, 2006

(30) Foreign Application Priority Data
Aug. 4, 2005 (JP) 2005-226057

(51) Int. Cl. F16D 31/02

(52) U.S. Cl. 60/384

(57) ABSTRACT

In a power-cylinder equipped power steering device, under a first condition where a first directional control valve disposed in a first pressure line receives fluid pressure supplied into a second pressure line by a reversible pump, the first directional control valve intercommunicates a reservoir and a first-pressure-line downstream passage section, and blocks fluid communication of the first-pressure-line upstream and downstream passage sections. Under a second condition where a second directional control valve receives fluid pressure supplied into the first pressure line by the pump, the first directional control valve intercommunicates the first-pressure-line upstream and downstream passage sections. Under the second condition, the second directional control valve intercommunicates the reservoir and the second-pressure-line downstream passage section, and blocks fluid communication of the second-pressure-line upstream and downstream passage sections. Under the first condition, the second directional control valve intercommunicates the second-pressure-line upstream and downstream passage sections.

### TECHNICAL FIELD

The present invention relates to a power steering device, and specifically to a hydraulic power cylinder equipped power steering device enabling steering assist force application by operating a hydraulic power cylinder by means of a motor-driven pump.

### BACKGROUND ART

A power steering device disclosed in Japanese Patent Provisional Publication No. 2003-137117 (hereinafter is referred to as “JP2003-137117”) is generally known as this type of power steering device. The power steering device disclosed in JP2003-137117 is comprised of an output shaft linked to the lower end of a steering shaft, a rack-and-pinion mechanism installed on the lower end of the output shaft for steering of steered road wheels, a hydraulic power cylinder linked to the rack shaft of the rack-and-pinion mechanism, and a motor-driven reversible pump provided for selectively supplying working fluid into either one of two power-cylinder chambers, connected to respective communication lines (respective pressure lines). When a normal steering operation is made by means of a steering wheel for left or right turns during vehicle driving, for the purpose of steering assist force application, working fluid (working pressure) is selectively supplied to either one of the hydraulic cylinder chambers by way of normal rotation or reverse rotation of the pump. Working pressure produced by the pump is supplied to the power cylinder and also acts on a directional control valve device (a selector valve device) comprised of a pair of poppet valves fluidly connected to the respective communication lines. The directional control valve device is provided to switch between fluid-communication and cutoff of each of the communication lines and a reservoir tank, based on pressure signals from the communication lines. Concretely, when working pressure, produced by the pump, acts on either one of the poppet valves depending on the direction of rotation of the pump, the one poppet valve operates to shut off or block fluid-communication between the reservoir tank and the communication line connected to the one poppet valve. On the other hand, the other poppet valve is held in its valve-open position to establish full fluid-communication between the reservoir tank and the other communication line, which is connected to the other poppet valve and into which working pressure is not supplied from the pump. In this manner, working fluid is exhausted from the power cylinder via the other communication line to the reservoir tank.

### SUMMARY OF THE INVENTION

However, suppose that, in the power steering device as disclosed in JP2003-137117, in order to remove dust, dirt, or other contaminants/impurities, a filter or a strainer is disposed in an induction passage (an inflow circuit) through which working fluid is drawn from the reservoir tank into an inlet-and-outlet port of the reversible pump. For instance, under a condition where part of working fluid exhausted from the left-hand cylinder chamber is drained into the reservoir, the remaining working fluid is drawn again into the reversible pump and then supplied into the right-hand cylinder chamber. Owing to recirculation of the unfiltered working fluid returned to the pump not through the filter, it is impossible to adequately remove undesirable contaminants from working fluid in the hydraulic lines.

It is, therefore, in view of the previously-described disadvantages of the prior art, an object of the invention to provide a power steering device, which is capable of efficiently removing or filtering out dust, dirt, or other contaminants/impurities from working fluid drawn into a reversible pump, while avoiding the contaminants from being drawn again into the pump.

In order to accomplish the aforementioned and other objects of the present invention, a power steering device comprises a hydraulic power cylinder configured to assist a steering force of a steering mechanism linked to steered road wheels, the hydraulic power cylinder defining therein a first cylinder chamber and a second cylinder chamber, a first pressure line connected to the first cylinder chamber, a second pressure line connected to the second cylinder chamber, a reversible pump having a first bi-directional port connected to the first pressure line and a second bi-directional port connected to the second pressure line, for selectively supplying working fluid pressure to either one of the first and second cylinder chambers, a motor that drives the pump in a normal-rotational direction or in a reverse-rotational direction, a motor control circuit that controls a driving state of the motor, a first directional control valve disposed in the first pressure line, a second directional control valve disposed in the second pressure line, a reservoir that stores therein working fluid, a first filter disposed in a first inflow line providing the working fluid from the reservoir to the second pressure line via the reversible pump, for filtering out contaminants from the working fluid, a second filter disposed in a second inflow line providing the working fluid from the reservoir to the first pressure line via the reversible pump, for filtering out contaminants from the working fluid, a first one-way valve disposed in the first inflow line, for permitting only a flow of the working fluid from the reservoir to the pump, a second one-way valve disposed in the second inflow line, for permitting only a flow of the working fluid from the reservoir to the pump, under a first condition where the first directional control valve receives the fluid pressure supplied into the second pressure line by the pump as a pilot pressure, the first directional control valve establishing fluid communication between the reservoir and a downstream passage section of the first pressure line extending from the first directional control valve to the first cylinder chamber, and blocking fluid communication between an upstream passage section extending from the first bi-directional port of the pump to the first directional control valve and the downstream passage section of the first pressure line, under a second condition where the fluid pressure is supplied into the first pressure line by the pump, the first directional control valve establishing fluid communication between the upstream and downstream passage sections of the first pressure line, under the second condition where the second directional control valve receives the fluid pressure supplied into the first pressure line by the pump as a pilot pressure, the second directional control valve establishing fluid communication between the reservoir and a downstream passage section of the second pressure line extending from the second directional control valve to the second cylinder chamber, and blocking fluid communication between an upstream passage section extending from the second bi-directional port of the pump to the second directional control valve and the downstream passage section of the second pressure line, and under the first condition where the fluid pressure is supplied into the second pressure line by the pump, the second directional control valve establishing fluid communication between the upstream and downstream passage sections of the second pressure line.

According to another aspect of the invention, a power steering device comprises a hydraulic power cylinder configured to assist a steering force of a steering mechanism linked to steered road wheels, the hydraulic power cylinder defining therein a first cylinder chamber and a second cylinder chamber, a first pressure line connected to the first cylinder chamber, a second pressure line connected to the second cylinder chamber, a reversible pump having a first bi-directional port connected to the first pressure line and a second-bi-directional port connected to the second pressure line, for selectively supplying working fluid pressure to either one of the first and second cylinder chambers, a motor that drives the pump in a normal-rotational direction or in a reverse-rotational direction, a motor control circuit that controls a driving state of the motor, a reservoir that stores therein working fluid, a first filter disposed in a first inflow line providing the working fluid from the reservoir to the second pressure line via the reversible pump, for filtering out contaminants from the working fluid, a second filter disposed in a second inflow line providing the working fluid from the reservoir to the first pressure line via the reversible pump, for filtering out contaminants from the working fluid, a first one-way valve disposed in the first inflow line, for permitting only a flow of the working fluid from the reservoir to the pump, a second one-way valve disposed in the second inflow line, for permitting only a flow of the working fluid from the reservoir to the pump, a first valve portion disposed in the first pressure line for receiving the fluid pressure in the first pressure line, a second valve portion disposed in the second pressure line for receiving the fluid pressure in the second pressure line, a pressure-receiving valve provided between the first and second valve portions, for operating the second valve portion by the fluid pressure in the first pressure line and for operating the first valve portion by the fluid pressure in the second pressure line, the pressure-receiving valve being responsive to the fluid pressure in the second pressure line for bringing the first valve portion to an operative state and for establishing fluid communication between the reservoir and the first cylinder chamber via the first valve portion, and the pressure-receiving valve being responsive to the fluid pressure in the first pressure line for bringing the second valve portion to an operative state and for establishing fluid communication between the reservoir and the second cylinder chamber via the second valve portion.

According to a further aspect of the invention, a method of controlling a power steering device comprises selectively supplying working fluid pressure produced by a reversible pump via a first pressure line and a second pressure line to either one of a first cylinder chamber and a second cylinder chamber defined in a hydraulic power cylinder configured to assist a steering force of a steering mechanism linked to steered road wheels, the first pressure line being connected to the first cylinder chamber and the second pressure line being connected to the second cylinder chamber, exhausting working fluid from the first cylinder chamber into a reservoir by establishing fluid communication between the first cylinder chamber and the reservoir via a first directional control valve disposed in the first pressure line, when the fluid pressure supplied into the second pressure line acts on the first directional control valve, exhausting working fluid from the second cylinder chamber into the reservoir by establishing fluid communication between the second cylinder chamber and the reservoir via a second directional control valve disposed in the second pressure line, when the fluid pressure supplied into the first pressure line acts on the second directional control valve, and supplying the working fluid from the reservoir into a negative-pressure line of the first and second pressure lines, when the fluid pressure in either one of the first and second pressure lines becomes a negative pressure.

According to a still further aspect of the invention, a power steering device comprises a hydraulic power cylinder configured to assist a steering force of a steering mechanism linked to steered road wheels, the hydraulic power cylinder defining therein a first cylinder chamber and a second cylinder chamber, a first pressure line connected to the first cylinder chamber, a second pressure line connected to the second cylinder chamber, a reversible pump having a first bi-directional port connected to the first pressure line and a second bi-directional port connected to the second pressure line, for selectively supplying working fluid pressure to either one of the first and second cylinder chambers, a driving means for driving the pump in a normal-rotational direction or in a reverse-rotational direction, a first directional control means disposed in the first pressure line, a second directional control means disposed in the second pressure line, a reservoir that stores therein working fluid, a first filter disposed in a first inflow line providing the working fluid from the reservoir to the second pressure line via the reversible pump, for filtering out contaminants from the working fluid, a second filter disposed in a second inflow line providing the working fluid from the reservoir to the first pressure line via the reversible pump, for filtering out contaminants from the working fluid, a first one-way valve disposed in the first inflow line, for permitting only a flow of the working fluid from the reservoir to the pump, a second one-way valve disposed in the second inflow line, for permitting only a flow of the working fluid from the reservoir to the pump, under a first condition where the first directional control means receives the fluid pressure supplied into the second pressure line by the pump as a pilot pressure, the first directional control means establishing fluid communication between the reservoir and a downstream passage section of the first pressure line extending from the first directional control means to the first cylinder chamber, and blocking fluid communication between an upstream passage section extending from the first bi-directional port of the pump to the first directional control means and the downstream passage section of the first pressure line, under a second condition where the fluid pressure is supplied into the first pressure line by the pump, the first directional control means establishing fluid communication between the upstream and downstream passage sections of the first pressure line, under the second condition where the second directional control means receives the fluid pressure supplied into the first pressure line by the pump as a pilot pressure, the second directional control means establishing fluid communication between the reservoir and a downstream passage section of the second pressure line extending from the second directional control means to the second cylinder chamber, and blocking fluid communication between an upstream passage section extending from the second bi-directional port of the pump to the second directional control means and the downstream passage section of the second pressure line, and under the first condition where the fluid pressure is supplied into the second pressure line by the pump, the second directional control means establishing fluid communication between the upstream and downstream passage sections of the second pressure line.

The other objects and features of this invention will become understood from the following description with reference to the accompanying drawings.

### BRIEF DESCRIPTION OF THE DRAWINGS

FIG. 1 is a system diagram illustrating an embodiment of a hydraulic power cylinder equipped power steering device.

FIG. 2 is a longitudinal cross-sectional view showing a state of each of first and second directional control valve devices incorporated in the power steering device of the embodiment, under a condition where there is no differential pressure (P1−P2=0) between first and second pressure lines connected to respective cylinder chambers of the hydraulic cylinder.

FIG. 3 is a longitudinal cross-sectional view showing a state of each of the first and second directional-control valve devices, under a condition where the fluid pressure P1 in the first pressure line is higher than the fluid pressure P2 in the second pressure line.

FIG. 4 is a hydraulic circuit diagram showing working fluid flow in the hydraulic system of the power steering device of the embodiment, during a steering assist operating mode during which a reversible pump is in its operative state and one rack-shaft stroke (a rack-shaft stroke in a negative x-axis direction) is assisted.

FIG. 5 is a hydraulic circuit diagram showing working fluid flow in the hydraulic system of the power steering device of the embodiment, during a steering assist operating mode during which the reversible pump is in its operative state and the opposite rack-shaft stroke (a rack-shaft stroke in a positive x-axis direction) is assisted.

FIG. 6 shows working fluid flow in the hydraulic system of the power steering device of the embodiment, when manual steering (manual steer) is made with an increase in steering wheel angle in the same steering direction in the presence of a failure in a fail-safe valve under a condition where the fail-safe valve has been energized (ON).

FIG. 7 shows working fluid flow in the hydraulic system of the power steering device of the embodiment, when manual steer is made in the opposite steering direction in the presence of the fail-safe valve failure under the condition where the fail-safe valve has been energized (ON).

FIG. 8 shows working fluid flow in the hydraulic system of the power steering device of the embodiment, when manual steer is made in the presence of a power steering control system failure or in the presence of a fail-safe valve failure under a condition where the fail-safe valve has been de-energized (OFF).

FIG. 9 is a longitudinal cross-sectional view showing a state of a modified directional-control valve device incorporated in a hydraulic power cylinder equipped power steering device, under a condition where there is no differential pressure (P1−P2=0) between first and second pressure lines connected to respective cylinder chambers.

FIG. 10 is a longitudinal cross-sectional view showing a state of the modified directional-control valve device, under a condition where there is a differential pressure {P1−P2}≠0} between the first and second pressure lines connected to the respective cylinder chambers.

### DESCRIPTION OF THE PREFERRED EMBODIMENTS

[Power Steering System Configuration]

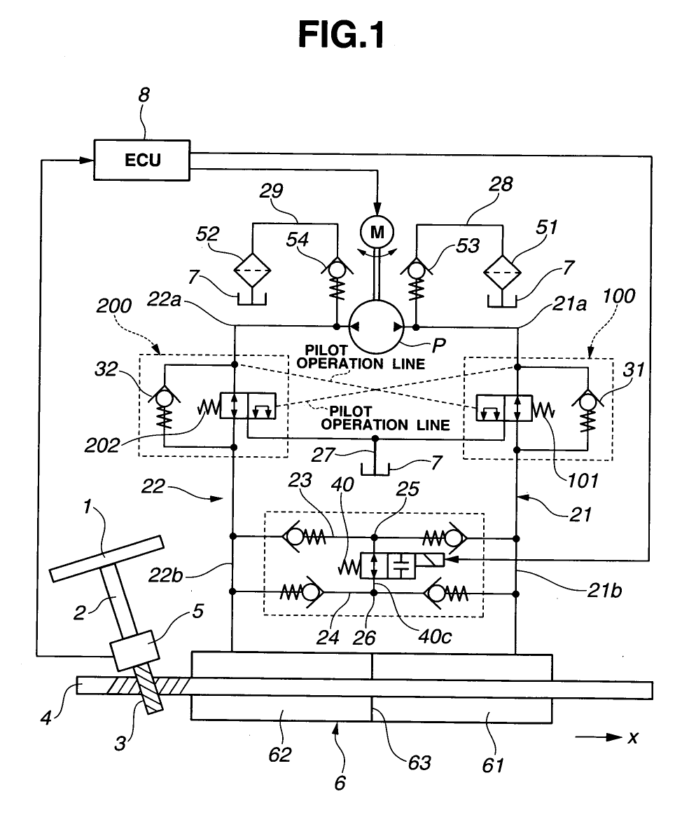

Referring now to the drawings, particularly to FIGS. 1-8, the power steering system of the embodiment is exemplified in an electronically-controlled hydraulic power steering system with a hydraulic power cylinder 6 and a reversible pump P.

(System Configuration)

In FIGS. 1 and 4-8, assuming that a directed line along a longitudinal direction of a steering rack shaft 4 is taken as x-axis, a direction oriented from a portion of the rack shaft substantially corresponding to a second pressure line (or a second fluid line or a second working-fluid communication passage) 22 to a portion of the rack shaft substantially corresponding-to a first pressure line (or a first fluid line or a first working-fluid communication passage) 21 is defined as a positive x-axis direction (a rightward direction in FIG. 1). In other words, a direction oriented from a portion of the rack shaft substantially corresponding to first pressure line 21 to a portion of the rack shaft substantially corresponding to second pressure line 22 is defined as a negative x-axis direction (a leftward direction in FIG. 1). As can be seen from the system diagram of FIG. 1, when a steering wheel 1 is turned by the driver, rotary motion of a pinion 3, formed on the lower end of a steering shaft 2, is converted into straight-line motion (linear motion) of rack shaft 4, thus causing steered wheels (front road wheels) to pivot to one side or the other side for steering. Pinion 3, which is formed on and fixed to the lower end of steering shaft 2, and rack shaft 4, which is the major cross member of the steering linkage and whose rack portion meshes with the pinion, construct the rack-and-pinion steering gear (the rack-and-pinion mechanism). The rack-and-pinion steering gear (4, 3) constructs the steering mechanism. As clearly shown in FIG. 1, a steering torque sensor (a steering assist force detector) 5 is installed on steering shaft 2, for detecting the magnitude and sense of steering torque applied to steering shaft 2 via steering wheel 1 by the driver. The sense of the applied steering torque means the direction of rotation of steering shaft 2. Steering torque sensor 5 outputs an informational data signal to an electronic control unit (ECU) 8 (described later). A power steering device is mounted on rack shaft 4, for assisting a rack stroke (linear motion) of rack shaft 4 responsively to the steering torque indicative signal from steering torque sensor 5. The power steering device is mainly comprised of an electric motor M (a driving source or a driving means), reversible pump P driven by motor M, and hydraulic power cylinder 6. Power cylinder 6 accommodates therein a piston 63, so that a pair of hydraulic cylinder chambers 61 and 62 are defined on both sides of piston 63. First cylinder chamber 61 is connected via first pressure line 21 to a first discharge port (a first inlet-and-outlet port or a first bi-directional port) of pump P, whereas second cylinder chamber 62 is connected via second pressure line 22 to a second discharge port (a second inlet-and-outlet port or a second bi-directional port) of pump P. Control unit 8 generally comprises a microcomputer. Control unit 8 includes an input/output interface (I/O), memories (RAM, ROM), and a microprocessor or a central processing unit (CPU). The input/output interface (I/O) of control unit 8 receives input information from various engine/vehicle sensors, at least steering torque sensor 5. Within control unit 8, the central processing unit (CPU) allows the access by the I/O interface of input informational data signals from the previously-discussed engine/vehicle sensors, that is, at least steering torque sensor 5. Concretely, the CPU of control unit 8 is responsible for carrying the control programs stored in memories and is capable of performing necessary arithmetic and logic operations for motor drive control and for fail-safe valve control. That is, control unit 8 includes a motor control circuit and a fail-safe valve control circuit. Computational results (arithmetic calculation results), that is, calculated output signals are relayed through the output interface circuitry of control unit 8 to output stages, namely, motor M and a fail-safe valve 40 (described later). The driving state of motor M is controlled responsively to a control command signal from the motor control circuit of control unit 8, so that pump P is rotated in a normal-rotational direction or in a reverse-rotational direction so as to selectively supply working fluid into either one of the first and second cylinder chambers 61 and 62 and thus a steering assist force is produced, thus enabling a rack stroke to be assisted.

(Hydraulic Circuit)

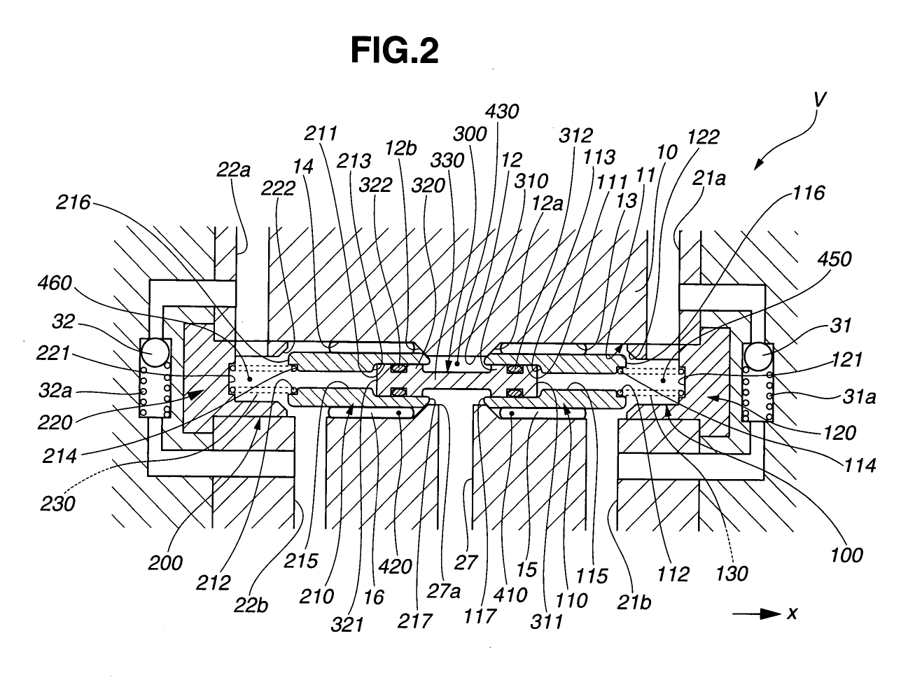

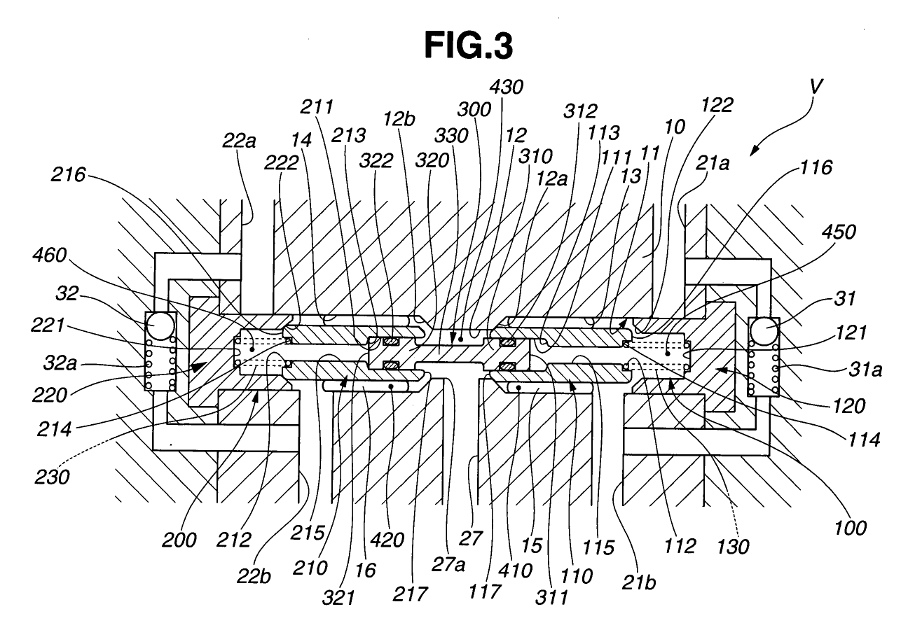

For working-fluid supply, the upstream passage section 21a of first pressure line 21 is connected via a first inflow line (a first working-fluid supply line) 28 to a reservoir tank (simply, a reservoir) 7, while the upstream passage section 22a of second pressure line 22 is connected via a second inflow line 29 to reservoir 7. In more detail, one end of first inflow line 28 is connected to the upstream passage section 21a of first pressure line 21, while the other end of first inflow line 28 is connected through a first inflow check valve (a first one-way valve) 53 to reservoir 7. In a similar manner, one end of second inflow line 29 is connected to the upstream passage section 22a of second pressure line 22, while the other end of second inflow line 29 is connected through a second inflow check valve (a second one-way valve) 54 to reservoir 7. A first directional control valve device (a first selector valve device or a first directional control means) 100 is disposed in the first pressure line 21, whereas a second directional control valve device (a second selector valve device or a second directional control means) 200 is disposed in the second pressure line 22. As clearly shown in FIG. 1, the first directional control valve device 100 is comprised of a first-pressure-line one-way valve 31 and a 3-port, 2-position, spring-offset, pilot-operation directional control valve 101. The second directional control valve device 200 is comprised of a second-pressure-line one-way valve 32 and a 3-port, 2-position, spring-offset, pilot-operation directional control valve 202. As-described later in reference to FIGS. 2 and 3, the 3-port, 2-position, spring-offset, pilot-operation directional control valve 101 of first directional control valve device 100 receives the fluid pressure P2 in second pressure line 22 via a pilot operation line as an external pilot pressure. In a similar manner, the 3-port, 2-position, spring-offset, pilot-operation directional control valve 202 of second directional control valve device 200 receives the fluid pressure P1 in first pressure line 21 via a pilot operation line as an external pilot pressure. That is, the valve position of each of pilot-operation directional control valves 101 and 202 can be mechanically changed depending on the differential pressure (P1−P2) between first and second pressure lines 21 and 22. When the pilot-operation directional control valve 101 of first directional control valve device 100 is held at its spring-loaded position, fluid communication between the upstream and downstream passage sections 21a and 21b of first pressure line 21 is established. Conversely when the pilot-operation directional control valve 101 of first directional control valve device 100 is held at its drain position owing to a differential pressure (P1−P2<0), the downstream passage section 21b of first pressure line 21 is communicated with reservoir 7 through a reservoir communication passage 27. When the pilot-operation directional control valve 202 of second directional control valve device 200 is held at its spring-loaded position, fluid communication between the upstream and downstream passage sections 22a and 22b of second pressure line 22 is established. Conversely when the pilot-operation directional control valve 202 of second directional control valve device 200 is held at its drain position owing to a differential pressure (P2−P1<0), the downstream passage section 22b of second pressure line 22 is communicated with reservoir 7 through reservoir communication passage 27. That is, the low-pressure side of the downstream passage section 21b of first pressure line 21 and the downstream passage section 22b of second pressure line 22 can be communicated with reservoir 7 via reservoir communication line 27 by means of the pilot-operation directional control valves 101 and 202 of first and second directional control valve devices 100 and 200. As can be seen from the hydraulic circuit diagram of FIG. 1, first-pressure-line one-way valve 31 is disposed in the first pressure line 21 and laid out in parallel with the first pilot-operation directional control valve 101, in such a manner as to intercommunicate the upstream and downstream passage sections 21a and 21b. First-pressure-line one-way valve 31 permits only the working-fluid flow from the upstream passage section 21a to the downstream passage section 21b therethrough. In a similar manner, second- pressure-line one-way valve 32 is disposed in the second pressure line 22 and laid out in parallel with the second pilot-operation directional control valve 202, in such a manner as to intercommunicate the upstream and downstream passage sections 22a and 22b. Second-pressure-line one-way valve 32 permits only the working-fluid flow from the upstream passage section 22a to the downstream passage section 22b therethrough.

By means of the pilot-operation directional control valve 101 of first directional control valve device 100 and the pilot-operation directional control valve 202 of second directional control valve device 200, when the fluid pressure P1 in first pressure line 21 is lower than the fluid pressure P2 in second pressure line 22, that is, in the case of P1<P2, owing to the fluid pressure P2 having a relatively higher pressure value and serving as the external pilot pressure for pilot-operation directional control valve 101, the pilot-operation directional control valve 101 of first directional control valve device 100 is held at the drain position. Thus, working fluid in the downstream passage section 21b of first pressure line 21 is drained into reservoir 7. This results in a differential pressure between the upstream and downstream passage sections 21a and 21b of first pressure line 21. Concretely, the fluid pressure in upstream passage section 21a becomes temporarily higher than that in downstream passage section 21b, and thus first-pressure-line one-way valve 31 becomes opened to permit the working fluid flow from upstream passage section 21a through first-pressure-line one-way valve 31 to downstream passage section 21b. As a result of this, the upstream passage section 21a as well as the downstream passage section 21b can be communicated with reservoir 7. Conversely when the fluid pressure P2 in second pressure line 22 is lower than the fluid pressure P1 in first pressure line 21, that is, in the case of P2<P1, owing to the fluid pressure P1 having a relatively higher pressure value and serving as the external pilot pressure for pilot-operation directional control valve 202, the pilot-operation directional control valve 202 of second directional control valve device 200 is held at the drain position. Thus, working fluid in the downstream passage section 22b of second pressure line 22 is drained into reservoir 7. This results in a differential pressure between the upstream and downstream passage sections 22a and 22b of second pressure line 22. Concretely, the fluid pressure in upstream passage section 22a becomes temporarily higher than that in downstream passage section 22b, and thus second-pressure-line one-way valve 32 becomes opened to permit the working fluid flow from upstream passage section 22a through second-pressure-line one-way valve 32 to downstream passage section 22b. As a result of this, the upstream passage section 22a as well as the downstream passage section 22b can be communicated with reservoir 7.

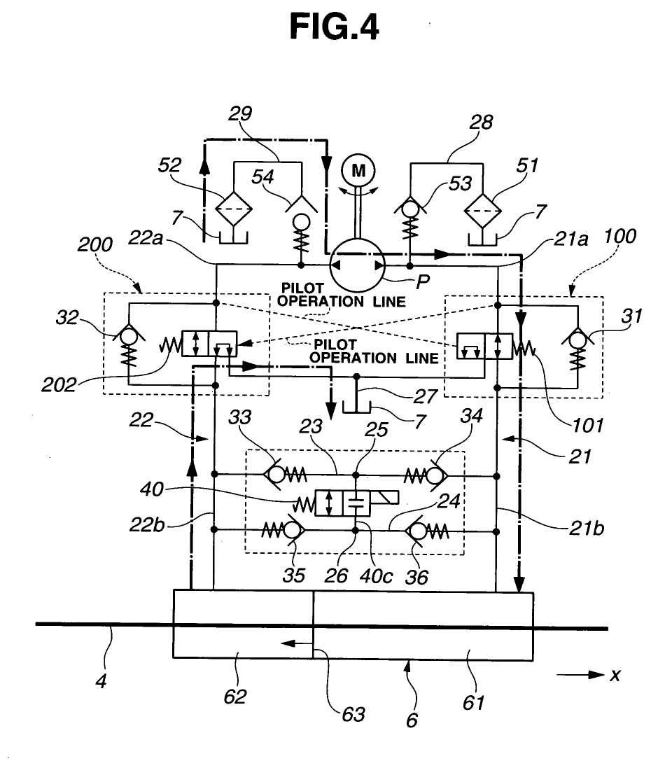

A communicating circuit or a bypass circuit (23, 24) is disposed between the downstream passage sections 21b and 22b of two pressure lines 21 and 22 for intercommunicating them not through pump P. Communicating circuit (23, 24) is comprised of a first communicating line (or a third fluid line) 23 and a second communicating line (or a fourth fluid line) 24. As can be seen from FIG. 1, first and second communicating lines 23 and 24 are laid out in parallel with each other. Fail-safe valve 40 is disposed in an intercommunication line 40c intercommunicating a substantially midpoint (a joined portion 25 described later) of the first communicating line (the third fluid line) 23 and a midpoint (a joined portion 26 described later) of the second communicating line (the fourth fluid line) 24, for establishing or blocking fluid communication between first and second communicating lines 23 and 24 by the fail-safe valve. A third one-way check valve 33 and a fourth one-way check valve 34 are disposed in the first communicating line 23 in a manner so as to sandwich therebetween the joined portion 25 of fail-safe valve 40 and first communicating line 23. Likewise, a fifth one-way check valve 35 and a sixth one-way check valve 36 are disposed in the second communicating line 24 in a manner so as to sandwich therebetween the joined portion 26 of fail-safe valve 40 and second communicating line 24. As best seen in FIG. 4, third check valve 33 is disposed in the first communicating line 23 for preventing the working-fluid flow from first communicating line 23 to downstream passage section 22b of second pressure line 22. Fourth check valve 34 is disposed in the first communicating line 23 for preventing the working-fluid flow from first communicating line 23 to downstream passage section 21b of first pressure line 21. In other words, third check valve 33 permits only the working fluid flow from downstream passage section 22b of second pressure line 22 to fail-safe valve 40, while fourth check valve 34 permits only the working fluid flow from downstream passage section 21b of first pressure line 21 to fail-safe valve 40. Fifth check valve 35 is disposed in the second communicating line 24 for permitting only the working-fluid flow from fail-safe valve 40 to downstream passage section 22b of second pressure line 22. On the other hand, sixth check valve 36 is disposed in the second communicating line 24 for permitting only the working fluid flow from fail-safe valve 40 to downstream passage section 21b of first pressure line 21. Therefore, when fail-safe valve 40 is held at its full fluid communication state (or at its valve-open position), downstream passage section 22b of second pressure line 22 is communicated with downstream passage section 21b of first pressure line 21 through third and sixth check valves 33 and 36 or through fourth and fifth check valves 34 and 35.

In the shown embodiment, fail-safe valve 40 is a normally-open, single solenoid-actuated, 2-port, 2-position, spring-offset directional control valve. During a normal power steering mode (or a normal hydraulic-pressure assist mode or a normal power-assist control mode or a normal steering-assist mode) where the power steering system is normally operating with no system failure, fail-safe valve 40 is held at its energized (ON) state in response to a control command signal from the fail-safe valve control circuit of control unit 8, and thus fail-safe valve 40 is kept at its closed state (i.e., a shutoff position). In contrast, in the presence of a power steering control system failure, such as breaking of a control signal line, an ECU failure and the like, fail-safe valve 40 is shifted to its spring-loaded position (i.e., a valve-open position or a de-energized position). Therefore, downstream passage section 22b of second pressure line 22 is communicated with downstream passage section 21b of first pressure line 21 through third and sixth check valves 33 and 36 or through fourth and fifth check valves 34 and 35, thus enabling manual steering (manual steer).

As previously described, first inflow check valve 53 (first one-way valve) is disposed in the first inflow line 28 for preventing back flow from the first port (the right-hand bi-directional port in FIG. 1) of pump P to reservoir 7, whereas second inflow check valve 54 (second one-way valve) is disposed in the second inflow line 29 for preventing back flow from the second port (the left-hand bi-directional port in FIG. 1) of pump P to reservoir 7. In the shown embodiment, each of first and second inflow check valves 53 and 54 is comprised of a ball check valve having a ball held by a spring against a seat. In lieu thereof, each of inflow check valves 53 and 54 may be comprised of a spring-loaded poppet check valve. Also provided is a first filter 51 disposed in a portion of first inflow line 28 just ahead of a right-hand suction port opening in the reservoir and connecting to the first inflow line, for efficiently removing or filtering out dust, dirt, or other contaminants/impurities from working fluid just before the working fluid is drawn from reservoir 7 into the right-hand suction port. Preferably, first filter 51 may be disposed in first inflow line 28 just ahead of the right-hand suction port for hermetically covering the right-hand suction port. Also provided is a second filter 52 disposed in a portion of second inflow line 29 just ahead of a left-hand suction port opening in the reservoir and connecting to the second inflow line, for efficiently removing or filtering out dust, dirt, or other contaminants/impurities from working fluid just before the working fluid is drawn from reservoir 7 into the left-hand. suction port. Preferably, second filter 52 may be disposed in second inflow line 29 just ahead of the left-hand suction port for hermetically covering the left-hand suction port.

Additionally, in the power steering system configuration shown in FIG. 1, during operation of pump P, the working fluid is supplied from reservoir 7 into a negative-pressure line of first and second pressure lines 21-22 via inflow check valves 53 and 54, when the fluid pressure in either one of first and second pressure lines 21-22 becomes a negative pressure.

Suppose that an oil filter or a strainer is disposed in reservoir communication passage 27. In such a case, there is a possibility that dust, dirt, or other contaminants (other impurities) undesirably exist in the hydraulic circuit. However, in the power steering device of the embodiment, filters 51-52 are disposed in the respective inflow lines 28-29, so that dust, dirt, or other contaminants (other impurities) can be satisfactorily removed or filtered out from working fluid just before the working fluid is drawn from reservoir 7 into either one of the first and second suction ports during operation of pump P. Thus, it is possible to certainly prevent dust, dirt, or other contaminants (other impurities) from entering the hydraulic system (the hydraulic circuits).

[Details of Directional Control Valve Devices]

Referring now to FIG. 2, there is shown the longitudinal cross section of each of first and second directional control valve devices 100 and 200. As can be appreciated from the cross section of FIG. 2, first and second directional control valve devices 100 and 200 are constructed as an integrated valve unit V. Substantially cylindrical valve portions 110 and 210 of first and second directional control valve devices 100 and 200 are axially slidably accommodated in a substantially cylindrical valve bore 11 of a valve housing (a valve body) 10. First and second directional control valve devices 100 and 200 are opened and closed by means of a pressure-receiving valve 300. In the longitudinal cross section of FIG. 2, an axial direction of valve bore 11, oriented from a portion of valve bore 11 substantially corresponding to second pressure line 22 (22a, 22b) to a portion of valve bore 11 substantially corresponding to first pressure line 21 (21a, 21b) is defined as the positive x-axis direction (the rightward direction in FIG. 1).

The inside diameter of the center section 12 of valve bore 11 is dimensioned to be relatively smaller than that of each of (i) a positive x-direction bore section 13 corresponding to the valve bore portion extending from the center section 12 in the positive x-direction and (ii) a negative x-direction bore section 14 corresponding to the valve bore portion extending from the center section 12 in the negative x-direction. Major component parts (110, 120, 130) of first directional control valve device 100 are operably accommodated in the positive x-direction bore section 13. On the other hand, major component parts (210, 220, 230) of second directional control valve device 200 are operably accommodated in the negative x-direction bore section 14. The structure and the shape are the same in the first and-second directional control valve devices 100 and 200. Concretely, first directional control valve device 100 is mainly comprised of the axially-movable first valve portion 110, a first stopper 120, and a first spring 130 (a compression coil spring). In a similar manner, second directional control valve device 200 is mainly comprised of the axially-movable second valve portion 210, a second stopper 220, and a second spring 230 (a compression coil spring). Each of first and second valve portions 110 and 210 is formed as a substantially cylindrical valve member having a stepped inner peripheral portion that defines a stepped bore. Each of first and second stoppers 120 and 220 is formed as a cup-shaped plug closed at one end. As seen from the cross section of FIG. 2, first and second valve portions 110 and 210 are axially slidably accommodated in the respective x-direction bore sections 13 and 14, such that the inside large-diameter through hole (corresponding to a first axial through hole or a first inside inner-peripheral portion 111 described later) of the stepped bore of first valve portion 110 and the inside large-diameter through hole (corresponding to a second axial through hole or a second inside inner-peripheral portion 211 described later) of the stepped bore of second valve portion 210 oppose to each other in the direction of the axis common to both of the first and second valve portions 110 and 210. Additionally, one axial end 310 of pressure-receiving valve 300 is slidably fitted into the inside large-diameter through-hole portion of the stepped bore of first valve portion 110, while the other axial end 320 of pressure-receiving valve 300 is slidably fitted into the inside large-diameter through-hole portion of the stepped bore of second valve portion 210. Pressure-receiving valve 300 functions as a differential-pressure-sensitive valve that creates axial movement of either the first valve portion 110 or the second valve portion 210, responsively to the differential pressure (P1−P2) between the fluid pressure P1 in first pressure line 21 and the fluid pressure P2 in second pressure line 22. As can be seen from the longitudinal cross section of FIG. 2, in the shown embodiment, first and second pilot-operation directional control valves 101 and 202 are symmetrically coaxially laid out with respect to the axis common to them.

Additionally, first directional control valve device 100 includes first-pressure-line one-way valve 31 that permits only the working-fluid flow from upstream passage section 21a to downstream passage section 21b, and a return spring 31a (a resilient means or a preloading device or a biasing device) that permanently biases or forces the valve portion (the ball) of first-pressure-line one-way valve 31 to remain closed. Likewise, second directional control valve device 200 includes second-pressure-line one-way valve 32 that permits only the working-fluid flow from upstream passage section 22a to downstream passage section 22b, and a return spring 32a (a resilient means or a preloading device or a biasing device) that permanently biases or forces the valve portion (the ball) of second-pressure-line one-way valve 32 to remain closed. When the differential pressure between upstream and downstream passage sections 21a and 21b of first-pressure-line one-way valve 31 is small, first-pressure-line one-way valve 31 remains closed by the spring 31a for preventing back flow from the first cylinder chamber 61 of power cylinder 6 to pump P. When the differential pressure between upstream and downstream passage sections 22a and 22b of second-pressure-line one-way valve 32 is small, second-pressure-line one-way valve 32 remains closed by the spring 32a for preventing back flow from the second cylinder chamber 62 of power cylinder 6 to pump P.

(1st and 2nd Valve Portions)

First valve portion 110 is slidably supported by means of an x-direction rib 15 formed on the inner peripheral wall of positive x-direction bore section 13 in such a manner as to be slidable in the x-axis direction. In a similar manner, second valve portion 210 is slidably supported by means of an x-direction rib 16 formed on the inner peripheral wall of negative x-direction bore section 14 in such a manner as to be slidable in the x-axis direction. A first working-fluid chamber 410 is defined between the outer periphery of first valve portion 110 and the inner periphery of positive x-direction bore section 13 of valve bore 11 by the x-direction rib 15. A second working-fluid chamber 420 is defined between the outer periphery of second valve portion 210 and the inner periphery of negative x-direction bore section 14 of valve bore 11 by the x-direction rib 16.

In more detail, first inside inner-peripheral portion 111 formed at the valve end of first valve portion 110 of the negative x-direction has a first inside shoulder portion 113. Additionally, first outside inner-peripheral portion 112 formed at the valve end of first valve portion 110 of the positive x-direction has a first outside shoulder portion 114. First inside inner-peripheral portion 111 is communicated with first pressure line 21 via a first-valve axial communication bore 115 whose inside diameter is dimensioned to be smaller than that of first inside inner-peripheral portion 111. Likewise, second inside inner-peripheral portion 211 formed at the valve end of second valve portion 210 of the positive x-direction has a second inside shoulder portion 213. Additionally, second outside inner-peripheral portion 212 formed at the valve end of second valve portion 210 of the negative x-direction has a second outside shoulder portion 214. Second inside inner-peripheral portion 211 is communicated with second pressure line 22 via a second-valve axial communication bore 215 whose inside diameter is dimensioned to be smaller than that of second inside inner-peripheral portion 211.

One end of first spring 130 is inserted into the first outside inner-peripheral portion 112 of first valve portion 110, and the first outside shoulder portion 114 of first valve portion 110 serves as a spring seat on which the spring end of first spring 130 of the negative x-direction rests. Likewise, one end of second spring 230 is inserted into the second outside inner-peripheral portion 212 of second valve portion 210, and the second outside shoulder portion 214 of second valve portion 210 serves as a spring seat on which the spring end of second spring 230 of the positive x-direction rests. The negative x-direction movement of first valve portion 110 is restricted or limited by way of abutment between a positive X-direction shoulder portion 12a of center valve-bore section 12 and the inside end (a negative x-direction end 117 described later) of first valve portion 110. On the other hand, the positive x-direction movement of second valve portion 210 is restricted or limited by way of abutment between a negative X-direction shoulder portion 12b of center valve-bore section 12 and the inside end (a positive x-direction end 217 described later) of second valve portion 210.

(1st and 2nd Stoppers)

First stopper (or first plug) 120 is fitted into the outermost end of x-direction bore section 13 of valve bore 11 formed in valve housing 10 in a fluid-tight fashion for closing the right-hand opening end of valve bore 11. Likewise, second stopper (or second plug) 220 is fitted into the outermost end of x-direction bore section 14 of valve bore 11 formed-in valve housing 10 in a fluid-tight fashion for closing the left-hand opening end of valve bore 11. The cup-shaped cylindrical hollow portion of first stopper 120 defines therein a first-stopper working-fluid chamber 450. The opposite end of first spring 130 is inserted in the first-stopper working-fluid chamber 450 and rests on the bottom face 121 of the cylindrical hollow portion of first stopper 120. Likewise, the cup-shaped cylindrical hollow portion of second stopper 220 defines therein a second-stopper working-fluid chamber 460. The opposite end of second spring 230 is inserted in the second-stopper working-fluid chamber 460 and rests on the bottom face 221 of the cylindrical hollow portion of second stopper 220. The positive x-direction movement of first valve portion 110 is restricted or limited by way of abutment between the opening end 122 of the cup-shaped cylindrical hollow portion of first stopper 120 and the outside end (a positive x-direction end 116) of first valve portion 110. In a similar manner, the negative x-direction movement of second valve portion 210 is restricted or limited by way of abutment between the opening end 222 of the cup-shaped cylindrical hollow portion of second stopper 220 and the outside end (a negative x-direction end 216) of second valve portion 210.

The axial lengths of first valve portion 110 and center valve-bore section 12 are dimensioned so that the negative x-direction end 117 of first valve portion 110 is spaced apart from the positive X-direction shoulder portion 12a under a condition where the positive x-direction end 116 of first valve portion 110 is in abutted-engagement with the opening end 122 of first stopper 120. Likewise, the axial lengths of second valve portion 210 and center valve-bore section 12 are dimensioned so that the positive x-direction end 217-of second valve portion 210 is spaced apart from the negative X-direction shoulder portion 12b under a condition where the negative x-direction end 216 of second valve portion 210 is in abutted-engagement with the opening end 222 of second stopper 220.

(Pressure-Receiving Valve)

Regarding pressure-receiving valve 300, as can be appreciated from the cross section of FIG. 2, outside diameters of the right-hand axial end 310 and the left-hand axial end 320 are the same, and the outside diameter of each of axial ends 310 and 320 is dimensioned to be greater than that of the pressure-receiving-valve center portion 330. Pressure-receiving valve 300 is formed into an iron-dumbbell shape in longitudinal cross section. A seal ring 312 is fitted to an annular seal groove formed in the outer periphery of the right-hand axial end 310, whereas a seal ring 322 is fitted to an annular seal groove formed in the outer periphery of the left-hand axial end 320. Thus, the right-hand axial end 310 is fitted into the first inside inner-peripheral portion 111 of first valve portion 110 via seal ring 312 in a fluid-tight fashion, such that axial sliding movement of the right-hand axial end 310 relative to the first inside inner-peripheral portion 111 is permitted. Similarly, the left-hand axial end 320 is fitted into the second inside inner-peripheral portion 211 of second valve portion 210 via seal ring 322 in a fluid-tight fashion, such that axial sliding movement of the left-hand axial end 320 relative to the second inside inner-peripheral portion 211 is permitted. The positive x-direction sliding movement of pressure-receiving valve 300 is restricted or limited by way of abutment between a positive x-direction axial end face 311 of valve 300 and the first inside shoulder portion 113 of first inside inner-peripheral portion 111 formed at the valve end of first valve portion 110. On the other hand, the negative x-direction sliding movement of pressure-receiving valve 300 is restricted or limited by way of abutment between a negative x-direction axial end face 321 of valve 300 and the second inside shoulder portion 213 of second inside inner-peripheral portion 211 formed at the valve end of second valve portion 210.

The outside diameter of pressure-receiving-valve center portion 330 is dimensioned to be smaller than the inside diameter of the center section 12 of valve bore 11, and whereby a third working-fluid chamber 430 is defined between the outer periphery of pressure-receiving-valve center portion 330 and the inner periphery of valve-bore center section 12. Additionally, by virtue of fluid-tight fit of the right-hand axial end face 310 to the first inside inner-peripheral portion 111 of first valve portion 110 via seal ring 312 and fluid-tight fit of the left-hand axial end face 320 to the second inside inner-peripheral portion 211 of second valve portion 210 via seal ring 322, fluid communication between first-valve axial communication bore 115 and third working-fluid chamber 430 and fluid communication between second-valve axial communication bore 215 and third working-fluid chamber 430 are permanently blocked.

(1st and 2nd Springs)

As previously discussed, the spring end of first spring 130 of the negative x-direction rests on the first outside shoulder portion 114 of first valve portion 110. The opposite end of first spring 130 (i.e., the spring end of first spring 130 of the positive x-direction) rests on the bottom face 121 of the cylindrical hollow portion of first stopper 120. First stopper 120 is fitted and fixed to the outermost end of x-direction bore section 13 of valve bore 11, and thus first spring 130 permanently forces the first valve portion 110 in the negative X-axis direction. In a similar manner, the spring end of second spring 230 of the positive x-direction rests on the second outside shoulder portion 214 of second valve portion 210. The opposite end of second spring 230 (i.e., the spring end of second spring 230 of the negative x-direction) rests on the bottom face 221 of the cylindrical hollow portion of second stopper 220. Second stopper 220 is fitted and fixed to the outermost end of negative x-direction bore section 14 of valve bore 11, and thus second spring 230 permanently forces the second valve portion 210 in the positive X-axis direction.

(Oil Passages)

First and second pressure lines 21 and 22, and reservoir communication passage 27, each of which is an oil passage, are formed in valve housing 10. First and second pressure lines 21 and 22, and reservoir communication passage 27 are connected to the integrated valve unit V constructing both of the first and second directional control valve devices 100 and 200. The upstream passage section 21a of first pressure line 21 is formed in valve housing 10 and provided at the fitted portion between first stopper 120 and valve bore 11. As can be seen from the right-hand half of the cross section of FIG. 2, the upstream passage section 21a opens to the first-stopper working-fluid chamber 450 defined in the cup-shaped cylindrical hollow portion of first stopper 120. On the other hand, the downstream passage section 21b of first pressure line 21 is formed in valve housing 10 and laid out in the negative x-axis direction from the opening end 122 of the cup-shaped cylindrical hollow portion of first stopper 120, such that the downstream passage section 21b opens to valve bore 11 in the positive x-axis direction from one axial end of x-direction rib 15 (i.e., the axial end of rib 15 of the positive x-direction) slidably supporting first valve portion 110. The opening of downstream passage section 21b and the right-hand end of first valve portion 110 are overlapped to each other in the x-axis direction. As previously discussed, first working-fluid chamber 410 is defined between the outer periphery of first valve portion 110 and the inner periphery of positive x-direction bore section 13 of valve bore 11 by the x-direction rib 15. Therefore, the downstream passage section 21b of first pressure line 21 always communicates the first working-fluid chamber 410. Likewise, the upstream passage section 22a of second pressure line 22 is formed in valve housing 10 and provided at the fitted portion between second stopper 220 and valve bore 11. As can be seen from the left-hand half of the cross section of FIG. 2, the upstream passage section 22a opens to the second-stopper working-fluid chamber 460 defined in the cup-shaped cylindrical hollow portion of second stopper 220. On the other hand, the downstream passage section 22b of second pressure line 22 is formed in valve housing 10 and laid out in the positive x-axis direction from the opening end 222 of the cup-shaped cylindrical hollow portion of second stopper 220, such that the downstream passage section 22b opens to valve bore 11 in the negative x-axis direction from one axial end of x-direction rib 16 (i.e., the axial end of rib 16 of the negative x-direction) slidably supporting second valve portion 210. The opening of downstream passage section 22b and the left-hand end of second valve portion 210 are overlapped to each other in the x-axis direction. As previously discussed, second working-fluid chamber 420 is defined between the outer periphery of second valve portion 210 and the inner periphery of negative x-direction bore section 14 of valve bore 11 by the x-direction rib 16. Therefore, the downstream passage section 22b of second pressure line 22 always communicates the second working-fluid chamber 420.

Reservoir communication passage 27 opens to the third working-fluid chamber 430 substantially at a midpoint of center valve-bore section 12. Third working-fluid chamber 430 is defined between the outer periphery of pressure-receiving-valve center portion 330 and the inner periphery of valve-bore center section 12. And thus, the opening 27a of reservoir communication passage 27 always communicates the third working-fluid chamber 430.

[Fluid-Communication and Cutoff States in Integrated Valve Unit V, Occurring Owing to Axial-Movement of Valve Portions]

(During Abutment Between Center Valve-Bore Section and 1st Valve Portion)

When first valve portion 110 moves in the negative x-axis direction and then the negative x-direction end 117 of first valve portion 110 is brought into abutted-engagement with the positive X-direction shoulder portion 12a of center valve-bore section 12, the positive x-direction end 116 of first valve portion 110 is spaced apart from the opening end 122 of first stopper 120. Under this condition, the upstream and downstream passage sections 21a and 21b of first pressure line 21 are communicated with each other through first-stopper working-fluid chamber 450. By abutment between the negative x-direction end 117 of first valve portion 110 and the positive X-direction shoulder portion 12a of center valve-bore section 12, fluid communication between first and third working-fluid chambers 410 and 430 is blocked. On the other hand, fluid communication between first-valve axial communication bore 115 and third working-fluid chamber 430 is always blocked. Thus, the working fluid flow from first working-fluid chamber 410 via first-stopper working-fluid chamber 450 and first-valve axial communication bore 115 to third working-fluid chamber 430 is shut off or stopped, thereby ensuring a complete cutoff state between first pressure line 21 and reservoir communication passage 27.

(During Abutment Between Center Valve-Bore Portion and 2nd Valve Portion)

In a similar manner, when second valve portion 210 moves in the positive x-axis direction and then the positive x-direction end 217 of second valve portion 210 is brought into abutted-engagement with the negative X-direction shoulder portion 12b of center valve-bore section 12, the negative x-direction end 216 of second valve portion 210 is spaced apart from the opening end 222 of second stopper 220. Under this condition, the upstream and downstream passage sections 22a and 22b of second pressure line 22 are communicated with each other through second-stopper working-fluid chamber 460. By abutment between the positive x-direction end 217 of second valve portion 210 and the negative X-direction shoulder portion 12b of center valve-bore section 12, fluid communication between the second and third working-fluid chambers 420 and 430 is blocked. On the other hand, fluid communication between second-valve axial communication bore 215 and third working-fluid chamber 430 is always blocked. Thus, the working fluid flow from second working-fluid chamber 420 via second-stopper working-fluid chamber 460 and second-valve axial communication bore 215 to third working-fluid chamber 430 is shut off or stopped, thereby ensuring a complete cutoff state between second pressure line 22 and reservoir communication passage 27.

(During Abutment Between Opening End of 1st Stopper and 1st Valve Portion)

When first valve portion 110 moves in-the positive x-axis direction and then the positive x-direction end 116 of first valve portion 110 is brought into abutted-engagement with the opening end 122 of first stopper 120, the negative x-direction end 117 of first valve portion 110 is spaced apart from the positive X-direction shoulder portion 12a of center valve-bore section 12. Under this condition, the first and third working-fluid chambers 410 and 430 are communicated with each other, and simultaneously the downstream passage section 21b of first pressure line 21 and reservoir 7 are communicated with each other via reservoir communication passage 27 and first working-fluid chamber 410. By abutment between the positive x-direction end 116 of first valve portion 110 and the opening end 122 of first stopper 120, fluid communication between first-stopper working-fluid chamber 450 and first working-fluid chamber 410 is blocked, and simultaneously fluid communication between the upstream passage section 21a of first pressure line 21 and each of first and third working-fluid chambers 410 and 430 is blocked.

(During Abutment Between Opening End of 2nd Stopper and 2ND Valve Portion)

When second valve portion 210 moves in the negative x-axis direction and then the negative x-direction end 216 of second valve portion 210 is brought into abutted-engagement with the opening end 222 of second stopper 220, the positive x-direction end 217 of second valve portion 210 is spaced apart from the negative X-direction shoulder portion 12b of center valve-bore section 12. Under this condition, the second and third working-fluid chambers 420 and 430 are communicated with each other, and simultaneously the downstream passage section 22b of second pressure line 22 and reservoir 7 are communicated with each other via reservoir communication passage 27 and second working-fluid chamber 420. By abutment between the negative x-direction end 216 of second valve portion 210 and the opening end 222 of second stopper 220, fluid communication between second-stopper working-fluid chamber 460 and second working-fluid chamber 420 is blocked, and simultaneously fluid communication between the upstream passage section 22a of second pressure line 22 and each of second and third working-fluid chambers 420 and 430 is blocked.

[Operating States of 1nd And 2nd Directional Control Valves]

First pressure line 21 always communicates first-valve axial communication bore 115 of first valve portion 110 and thus the fluid pressure P1 in first pressure line 21 is introduced into first-valve axial communication bore 115, whereas second pressure line 22 always communicates second-valve axial communication bore 215 of second valve portion 210 and thus the fluid pressure P2 in second pressure line 22 is introduced into second-valve axial communication bore 215. The fluid pressure P1 acts on the positive x-direction axial end face 311 of pressure-receiving valve 300, while the fluid pressure P2 acts on the negative x-direction axial end face 321 of pressure-receiving valve 300.

Regarding the fluid-communication and cutoff operation of first directional control valve device 100, when the fluid pressure P2, supplied into second pressure line 22 by means of pump P, acts on the negative x-direction axial end face 321 of pressure-receiving valve 300, first directional control valve device 100 operates to establish fluid communication between downstream passage section 21b of first pressure line 21 and reservoir communication passage 27 (i.e., reservoir 7) by axial movement of the negative x-direction end 117 of first valve portion 110 apart from the positive X-direction shoulder portion 12a of center valve-bore section 12, and simultaneously to block fluid communication between upstream and downstream passage sections 21a-21b of first pressure line 21 by abutment between the positive x-direction end 116 of first valve portion 110 and the opening end 122 of first stopper 120. Conversely when the fluid pressure P1, supplied into first pressure line 21 by means of pump P, acts on the positive x-direction axial end face 311 of pressure-receiving valve 300, fluid communication between the upstream and downstream passage sections 21a-21b of first pressure line 21 is established.

Regarding the fluid-communication and cutoff operation of second directional control valve device 200, when the pressure P1, supplied into first pressure line 21 by means of pump P, acts on the positive x-direction axial end face 311 of pressure-receiving valve 300, second directional control valve device 200 operates to establish fluid communication between downstream passage section 22b of second pressure line 22 and reservoir communication passage 27 (i.e., reservoir 7) by axial movement of the positive x-direction end 217 of second valve portion 210 apart from the negative X-direction shoulder portion 12b of center valve-bore section 12, and simultaneously to block fluid communication between upstream and downstream passage sections 22a-22b of second pressure line 22 by abutment between the negative x-direction end 216 of second valve portion 210 and the opening end 222 of second stopper 220. Conversely when the fluid pressure P2, supplied into second pressure line 22 by means of pump P, acts on the negative x-direction axial end face 321 of pressure-receiving valve 300, fluid communication between the upstream and downstream passage sections 22a-22b of second pressure line 22 is established.

First spring 130, operably disposed in first directional control valve device 100, permanently forces the first valve portion 110 in the negative x-axis direction in such a manner as to maintain the fluid-communication state of second-pressure-line downstream passage section 22b and reservoir 7 in the opposite directional control valve side (i.e., in the second directional control valve side). On the other hand, second spring 230, operably disposed in second directional control valve device 200, permanently forces the second valve portion 210 in the positive x-axis direction in such a manner as to maintain the fluid-communication state of first-pressure-line downstream passage section 21b and reservoir 7 in the opposite directional control valve side (i.e., in the first directional control valve side).

According to the integrated valve configuration shown in FIG. 2, in order to establish fluid communication between first-pressure-line downstream passage section 21b and reservoir communication passage 27 (reservoir 7) in first directional control valve device 100, the system utilizes the spring force of second spring 230 as well as the fluid pressure acting on pressure-receiving valve 300. In order to establish fluid communication between second-pressure-line downstream passage section 22b and reservoir communication passage 27 (reservoir 7) in second directional control valve device 200, the system utilizes the spring force of first spring 130 as well as the fluid pressure acting on pressure-receiving valve 300. Even when there is a less differential pressure (P1−P2) between the two fluid pressures P1 and P2 introduced into the integrated valve unit V, constructing first and second directional control valve devices 100 and 200, it is possible to reliably shift either one of first and second directional control valve devices 100 and 200 to the fluid-communication state of pressure-line downstream passage section (21b; 22b) and reservoir 7 by virtue of the spring force. This enhances the responsiveness of valve axial movement to the differential pressure.

(FIG. 2: Under Condition Where There Is No Differential Pressure (P1−P2=0) Between 1st and 2nd Pressure Lines)

When the fluid pressure P1 in first pressure line 21 is identical to the fluid pressure P2 in second pressure line 22, that is, in the case of P1=P2, for example, when motor M is conditioned in its stopped state, the force acting on the positive x-direction axial end face 311 of valve 300, resulting from the fluid pressure P1, and the force acting on the negative x-direction axial end face 321 of valve 300, resulting from the fluid pressure P2, are balanced to each other. Thus, pressure-receiving valve 300 is shifted to and held at its neutral position (i.e., a substantially midpoint of valve bore 11 in the x-axis direction). At the same time, first valve portion 110 is brought into abutted-engagement with the positive X-direction shoulder portion 12a of center valve-bore section 12 by way of the spring force of first spring 130, while second valve portion 210 is brought into abutted-engagement with the negative X-direction shoulder portion 12b of center valve-bore section 12 by way of the spring force of second spring 230. Thus, in the case of P1=P2, first valve portion 110 is held apart from the opening end 122 of first stopper 120, while second valve portion 210 is held apart from the opening end 222 of second stopper 220. As a result, fluid communication between first working-fluid chamber 410 and first-stopper working-fluid chamber 450 is established, and simultaneously fluid communication between second working-fluid chamber 420 and second-stopper working-fluid chamber 460 is established. Under these conditions, upstream and downstream passage sections 21a-21b of first pressure line 21 are communicated with each other and upstream and downstream passage sections 22a-22b of second pressure line 22 are communicated with each other. Under the condition defined by P1=P2, by abutment between the negative x-direction end 117 of first valve portion 110 and the positive X-direction shoulder portion 12a of center valve-bore section 12, fluid communication between first and third working-fluid chambers 410 and 430 is blocked. Additionally, by abutment between the positive x-direction end 217 of second valve portion 210 and the negative X-direction shoulder portion 12b of center valve-bore section 12, fluid communication between second and third working-fluid chambers 420 and 430 is blocked. Therefore, under the condition defined by P1=P2, fluid communication between first pressure line 21 and reservoir communication passage 27 (i.e., reservoir 7) is blocked and fluid communication between second pressure line 22 and reservoir communication passage 27 (i.e., reservoir 7) is also blocked.

(FIG. 3: Under Condition Where There is a Differential Pressure (P1−P2≠0) Between 1st and 2nd Pressure Lines)

When the fluid pressure P1 in first pressure line 21 is high and the fluid pressure P2 in second pressure line 22 is low, that is, in the case of P1>P2, the force acting on the positive x-direction axial end face 311 of valve 300, resulting from the fluid pressure P1, becomes greater than the force acting on the negative x-direction axial end face 321 of valve 300, resulting from the fluid pressure P2. Owing to the differential pressure (P1−P2>0), pressure-receiving valve 300 displaces from the neutral position in the negative x-axis direction, and thus the negative x-direction axial end face 321 of valve 300 is kept in abutted-engagement with the second inside shoulder portion 213 of second valve portion 210. Under these conditions, the pressure differential (P1−P2) acts on the second valve portion 210 via pressure-receiving valve 300, so that second valve portion 210 is pushed by the pressure differential (P1−P2>0) in the negative x-axis direction. On the other hand, second spring 230 permanently forces second valve portion 210 in the positive x-axis direction. For the reasons discussed above, when the pressure differential (P1−P2) becomes greater than the spring force of second spring 230, second valve portion 210 begins to move against the spring force in the negative x-axis direction. Then, second valve portion 210 is brought into abutted-engagement with second stopper 220. Under these conditions, fluid communication between second working-fluid chamber 420 and second-stopper working-fluid chamber 460 is blocked. At the same time, the upstream passage section 22a of second pressure line 22 is shut off by means of second directional control valve device 200 (exactly, by abutment between the opening end 222 of second stopper 220 and the negative x-direction end 216 of second valve portion 210), while the downstream passage section 22b of second pressure line 22 is communicated with reservoir communication passage 27 (i.e., reservoir 7).

Under the condition defined by P1>P2, the first inside shoulder portion 113 of first valve portion 110 is kept out of abutted-engagement with the positive x-direction axial end face 311 of pressure-receiving valve 300. Therefore, first valve portion 110 is forced in the negative x-axis direction by the spring force of first spring 130 and thus the negative x-direction end 117 of first valve portion 110 is brought into abutted-engagement with the positive X-direction shoulder portion 12a of center valve-bore section 12. Under these conditions, fluid communication between first and third working-fluid chambers 410 and 430 is blocked and simultaneously the upstream and downstream passage sections 21a-21b of first pressure line 21 are communicated with each other through first-stopper working-fluid chamber 450. As set forth above, in the case of P1>P2, regarding first pressure line 21, upstream and downstream passage sections 21a-21b are communicated with each other, while fluid communication between reservoir communication passage 27 and downstream passage section 21b is blocked. In the case of P1>P2, regarding second pressure line 22, fluid communication between upstream and downstream passage sections 22a-22b is blocked, while reservoir communication passage 27 and downstream passage section 22b are communicated with each other.

Conversely when the fluid pressure P2 in second pressure line 22 is high and the fluid pressure P1 in first pressure line 21 is low, that is, in the case of P2>P1, the force acting on the negative x-direction axial end face 321 of valve 300, resulting from the fluid pressure P2, becomes greater than the force acting on the positive x-direction axial end face 311 of valve 300, resulting from the fluid pressure P1. Owing to the differential pressure (P1−P2<0), pressure-receiving valve 300 displaces from the neutral position in the positive x-axis direction, and thus the positive x-direction axial end face 311 of valve 300 is kept in abutted-engagement with the first inside shoulder portion 113 of first valve portion 110. Under the condition defined by P2>P1, fluid communication between first working-fluid chamber 410 and first-stopper working-fluid chamber 450 is blocked. At the same time, the upstream passage section 21a of first pressure line 21 is shut off by means of first directional control valve device 100 (exactly, by abutment between the opening end 122 of first stopper 120 and the positive x-direction end 116 of first valve portion 110), while the downstream passage section 21b of first pressure line 21 is communicated with reservoir communication passage 27 (i.e., reservoir 7).

Under the condition defined by P2>P1, the second inside shoulder portion 213 of second valve portion 210 is kept out of abutted-engagement with the negative x-direction axial end face 321 of pressure-receiving valve 300. Therefore, second valve portion 210 is forced in the positive x-axis direction by the spring force of second spring 230 and thus the positive x-direction end 217 of second valve portion 210 is brought into abutted-engagement with the negative X-direction shoulder portion 12b of center valve-bore section 12. Under these conditions, fluid communication between second and third working-fluid chambers 420 and 430 is blocked and simultaneously the upstream and downstream passage sections 22a-22b of second pressure line 22 are communicated with each other through second-stopper working-fluid chamber 460. As set forth above, in the case of P2>P1, regarding second pressure line 22, upstream and downstream passage sections 22a-22b are communicated with each other, while fluid communication between reservoir communication passage 27 and downstream passage section 22b is blocked. In the case of P2>P1, regarding first pressure line 21, fluid communication between upstream and downstream passage sections 21a-21b is blocked, while reservoir communication passage 27 and downstream passage section 21b are communicated with each other.

[Working Fluid Flow]

(Hydraulic-Pressure Assist)

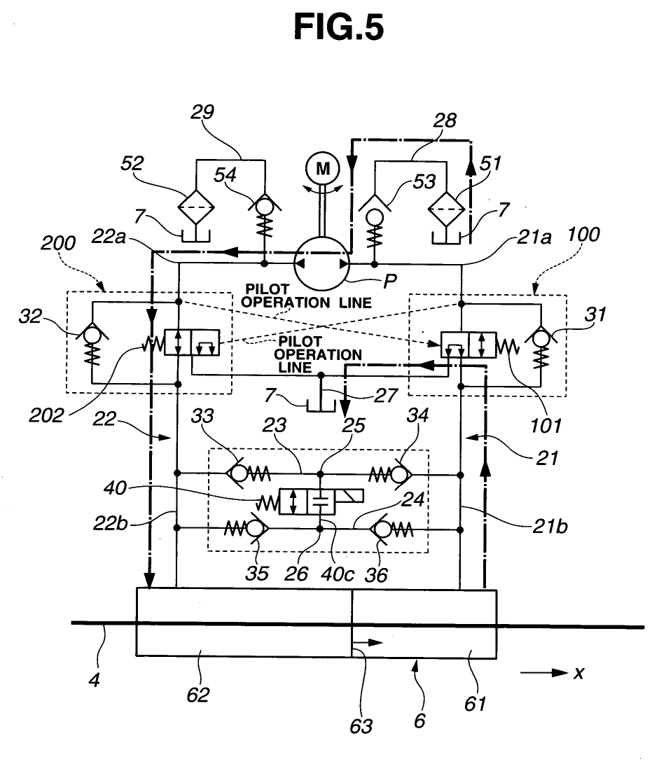

Referring now to FIGS. 4-5, there are shown the hydraulic circuit diagrams concerning working fluid flow in the hydraulic system, during the hydraulic-pressure assist mode (the steering assist operating mode). FIG. 4 shows the working fluid flow in the hydraulic system during the hydraulic-pressure assist mode, at which a stroke of rack shaft 4 of the negative x-axis direction is assisted by way of hydraulic pressure (working fluid pressure) produced by pump P. FIG. 5 shows the working fluid flow in the hydraulic system during the hydraulic-pressure assist mode, at which a stroke of rack shaft 4 of the positive x-axis direction is assisted by way of hydraulic pressure (working fluid pressure) produced by pump P.

As shown in FIG. 4, when rack shaft 4 is assisted in the negative x-axis direction, working fluid is pumped out from reservoir 7 through second filter 52 and second inflow check valve 54, and thus delivered into first pressure line 21. At this time, the fluid pressure P1 in first pressure line 21 becomes higher than the fluid pressure P2 in second pressure line 22. Upstream and downstream passage sections 21a-21b of first pressure line 21 are communicated with each other via first directional control valve device 100, and as a result working fluid is supplied into first cylinder chamber 61. On the other hand, by means of second directional control valve device 200, the upstream passage section 22a of second pressure line 22 is shut off from the downstream passage section 22b, while the downstream passage section 22b is communicated with the reservoir communication passage 27. Therefore, all of the working fluid, which is exhausted from second cylinder chamber 62 into downstream passage section 22b owing to a decrease in volumetric capacity of second cylinder chamber 62, returns to reservoir 7 by means of second directional control valve device 200. When re-pumping out the working fluid returned to the reservoir, the returned working fluid is filtered out by the second filter 52 and the filtered working fluid is introduced into the hydraulic circuit.

As shown in FIG. 5, when rack shaft 4 is assisted in the positive x-axis direction, working fluid is pumped out from reservoir 7 through first filter 51 and first inflow check valve 53, and thus delivered into second pressure line 22. At this time, the fluid pressure P2 in second pressure line 22 becomes higher than the fluid pressure P1 in first pressure line 21. Upstream and downstream passage sections 22a-22b of second pressure line 22 of a relatively higher pressure value rather than first pressure line 21 are communicated with each other via second directional control valve device 200, and as a result working fluid is supplied into second cylinder chamber 62. On the other hand, by means of first directional control valve device 100, the upstream passage section 21a of first pressure line 21 is shut off from the downstream passage section 21b, while the downstream passage section 21b is communicated with the reservoir communication passage 27. Therefore, all of the working fluid, which is exhausted from first cylinder chamber 61 into downstream passage section 21b owing to a decrease in volumetric capacity of first cylinder chamber 61, returns to reservoir 7 by means of first directional control valve device 100. When re-pumping out the working fluid returned to the reservoir, the returned working fluid is filtered out by the first filter 51 and the filtered working fluid is introduced into the hydraulic circuit.

As set out above, during the rack-shaft stroke irrespective of whether the rack shaft is moving in the negative x-axis direction or in the positive x-axis direction, all of the working fluid, which has been exhausted from hydraulic power cylinder 6, can be returned to reservoir 7 by means of first or second directional control valve devices 100-200, and then efficiently filtered out by means of first or second filters 51-52, and re-pumped out and introduced into the hydraulic circuit.

(Manual Steer With Steering-Wheel-Angle Increase
<Fail-Safe Valve Energized and Then Failed>)

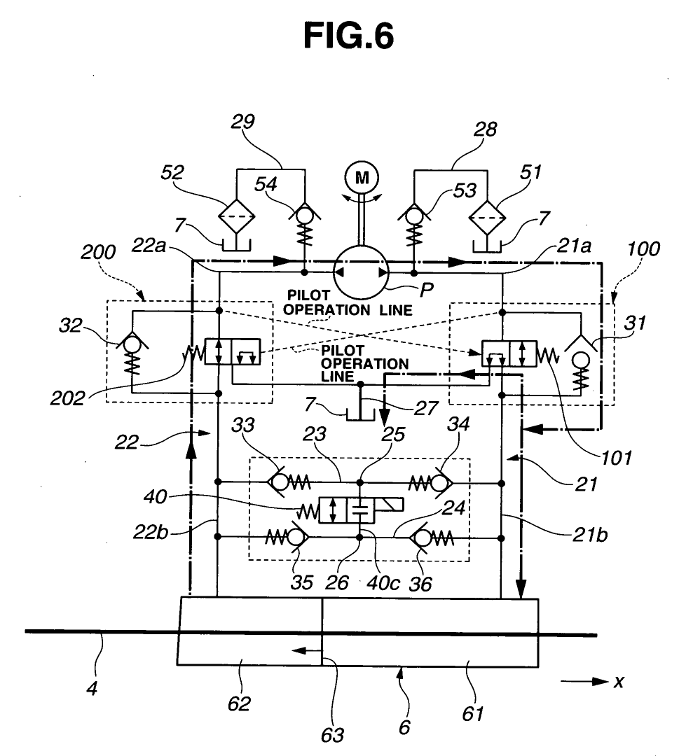

Referring now to FIG. 6, there is shown the hydraulic circuit diagram concerning the working fluid flow in the hydraulic system during the manual steering with an increase in steering wheel angle in the same steering direction under a specified condition where fail-safe valve 40 has been energized (ON) and then failed. In more detail, FIG. 6 shows the manual steering state that the valve spool of fail-safe valve 40 has been stuck in the energized (ON) state (i.e., the closed position) and rack shaft 4 moves in the negative x-axis direction due to the steering-wheel-angle increase. In the presence of a fail-safe valve failure that fail-safe valve 40 has been stuck in the energized state, the hydraulic-pressure assist mode created by driving pump P is not executed. When steering wheel 1 is turned by the driver and thus rack shaft 4 is moved in the negative x-axis direction, the volumetric capacity of first cylinder chamber 61 increases, while the volumetric capacity of second cylinder chamber 62 decreases. Thus, the fluid pressure P1 in first pressure line 21 becomes low, while the fluid pressure P2 in second pressure line 22 becomes high. With the first valve portion 110 of first directional control valve device 100 pilot-operated by the fluid pressure P2 (>P1) in second pressure line 22 higher than the fluid pressure P1 in first pressure line 21), the downstream passage section 21b of first pressure line 21 is communicated with reservoir communication passage 27. Regarding the second directional control valve side (2^{nd} directional control valve device 200), upstream and downstream passage sections 22a-22b of second pressure line 22 are communicated with each other. By means of first directional control valve device 100, the upstream passage section 21a of first pressure line 21 is shut off from the downstream passage section 21b. Thus, the fluid pressure P2 in second pressure line 22, which becomes high, acts on first-pressure-line one-way valve 31 via pump P, with the result that first-pressure-line one-way valve 31 becomes opened and working fluid flows through first-pressure-line one-way valve 31 into first cylinder chamber 61. In this manner, manual steer can be ensured. As can be seen from the working fluid flow indicated by the one-dotted line in FIG. 6, on the other hand, the downstream passage section 21b of first pressure line 21 is communicated with reservoir communication passage 27. Thus, a part of the working fluid passing through first-pressure-line one-way valve 31 is drained into reservoir 7.

(Manual Steer With Steering Wheel Returning in the Opposite Steering Direction <Fail-Safe Valve Energized and then Failed>)

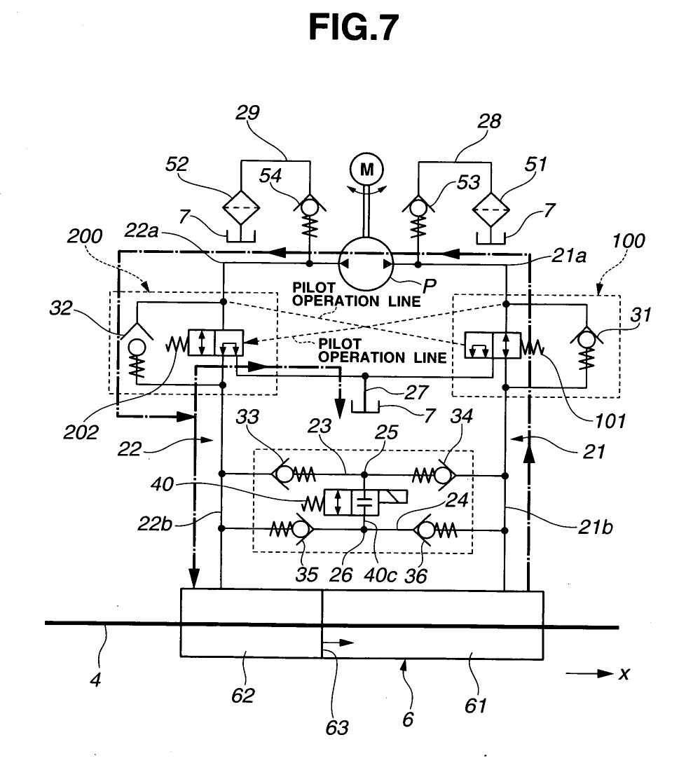

Referring now to FIG. 7, there is shown the hydraulic circuit diagram concerning the working fluid flow in the hydraulic system during the manual steering that steering wheel 1 returns in the opposite steering direction owing to a reaction force fed back from the tire via the steering linkage to rack shaft 4 under the specified condition where fail-safe valve 40 has been energized (ON) and then failed. In more detail, FIG. 7 shows the manual steering state that the valve spool of fail-safe valve 40 has been stuck in the energized (ON) state and rack shaft 4 moves in the positive x-axis direction due to the reaction force fed back from the tire to rack shaft 4. When rack shaft 4 moves in the positive x-axis direction due to the reaction force, the volumetric capacity of first cylinder chamber 61 decreases and thus the fluid pressure in first cylinder chamber 61 becomes high, while the volumetric capacity of second cylinder chamber 62 increases and thus the fluid pressure in second cylinder chamber 62 becomes low. Thus, in the case of the steering wheel returning to the opposite steering direction by the reaction force fed back from the tire, the fluid pressure P1 in first pressure line 21 becomes high, while the fluid pressure P2 in second pressure line 22 becomes low. With the second valve portion 210 of second directional control valve device 200 pilot-operated by the fluid pressure P1 (>P2) in first pressure line 21 higher than the fluid pressure P2 in second pressure line 22) and with the first valve portion 110 of first directional control valve device 100 held at the valve-open position, upstream and downstream passage sections 21a-21b of first pressure line 21 are communicated with each other, while the downstream passage section 22b of second pressure line 22 is communicated with reservoir communication passage 27. By means of second directional control valve device 200, the upstream passage section 22a of second pressure line 22 is shut off from the downstream passage section 22b. Thus, the fluid pressure P1 in first pressure line 21, which becomes high, acts on second-pressure-line one-way valve 32 via pump P, with the result that second-pressure-line one-way valve 32 becomes opened and working fluid flows through second-pressure-line one-way valve 32 into second cylinder chamber 62. In this manner, manual steer can be ensured. As can be seen from the working fluid flow indicated by the one-dotted line in FIG. 7, on the other hand, the downstream passage section 22b of second pressure line 22 is communicated with reservoir communication passage 27. Thus, a part of the working fluid passing through second-pressure-line one-way valve 32 is-drained into reservoir 7.

As discussed above, even when manual steer is made under a specified condition where fail-safe valve 40 has been energized (ON) and then failed, a part of working fluid exhausted from power cylinder 6 can be returned to reservoir 7 by means of first or second directional control valve devices 100-200, and thus it is possible to reliably remove undesirable contaminants contained in working fluid in the hydraulic circuit.

(Manual Steer <In the Presence of a Power Steering System Failure or in the Presence of a Failure in Fail-Safe Valve De-Energized>)

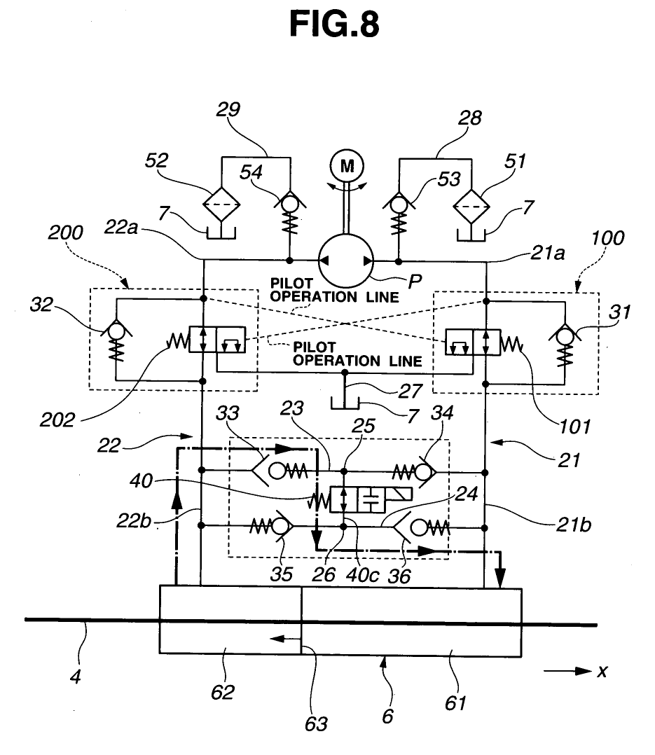

Referring now to FIG. 8, there is shown the hydraulic circuit diagram concerning the working fluid flow in the hydraulic system during the manual steering under a specified condition where a power steering system failure, such as breaking of a control signal line, an ECU failure and the like, occurs or a fail-safe valve failure occurs with fail-safe valve 40 de-energized. When the power steering system failure has occurred, generally, the normally-opened fail-safe valve 40 is shifted to its valve-open position by the spring bias of a fail-safe valve return spring. If a failure in fail-safe valve 40 occurs even under a condition where the power steering system is operating normally, the hydraulic-pressure assist mode created by driving pump P is not executed. When steering wheel 1 is turned by the driver and thus rack shaft 4 is moved in the negative x-axis direction, the volumetric capacity of first cylinder chamber 61 increases and thus the fluid pressure in first cylinder chamber 61 becomes low, while the volumetric capacity of second cylinder chamber 62 decreases and thus the fluid pressure in second cylinder chamber 62 becomes high. Thus, the fluid pressure in second cylinder chamber 62 acts on third and fifth check valves 33 and 35. Thereafter, the fluid pressure in second cylinder chamber 62 acts on fourth check valve 34 and fail-safe valve 40 via the opened third check valve 33. The flow of working fluid from second cylinder chamber 62 through third check valve 33 into first communicating line 23 is shut off by means of fourth check valve 34. With fail-safe valve 40 opened, the fluid pressure in second cylinder chamber 62 also acts on sixth check valve 36, and thus sixth check valve 36 becomes opened. Thus, the working fluid, exhausted from second cylinder chamber 62, flows through the second passage section 22b of second pressure line 22 via third check valve 33, fail-safe valve 40, sixth check valve 36, and the second passage section 21b of first pressure line 21 into first cylinder chamber 61. Conversely when steering wheel 1 is turned by the driver and thus rack shaft 4 is moved in the positive x-axis direction, the volumetric capacity of second cylinder chamber 62 increases and thus the fluid pressure in second cylinder chamber 62 becomes low, while the volumetric capacity of first cylinder chamber 61 decreases and thus the fluid pressure in first cylinder chamber 61 becomes high. Thus, the fluid pressure in first cylinder chamber 61 acts on fourth and sixth check valves 34 and 36. Thereafter, the fluid pressure in first cylinder chamber 61 acts on third check valve 33 and fail-safe valve 40 via the opened fourth check valve 34. The flow of working fluid from first cylinder chamber 61 through fourth check valve 34 into first communicating line 23 is shut off by means of third check valve 33. With fail-safe valve 40 opened, the fluid pressure in first cylinder chamber 61 also acts on fifth check valve 35, and thus fifth check valve 35 becomes opened. Thus, the working fluid, exhausted from first cylinder chamber 61, flows through the second passage section 21b of first pressure line 21 via fourth check valve 34, fail-safe valve 40, fifth check valve 35, and the second passage section 22b of second pressure line 22 into second cylinder chamber 62. In this manner, manual steer can be ensured.

[Comparison of Operation and Effects of Power Steering Device of the Embodiment Differentiated from the Prior Art]

In the prior art power steering device, working pressure, produced by a reversible pump, is selectively supplied to either one of cylinder chambers of a hydraulic power cylinder via either one of pressure lines, while the other pressure line, into which working pressure is not supplied from the reversible pump, and a reservoir are communicated with each other via a directional control valve device comprised of a pair of poppet valves fluidly connected to the respective pressure lines, so as to drain the working fluid from the contracting cylinder chamber of the power cylinder to the reservoir. However, in the prior art device, only a part of the working fluid exhausted from the contracting cylinder chamber is drained into the reservoir. The remaining working fluid is not drained into the reservoir. But, the remaining working fluid is undesirably drawn into the reversible pump and re-pumped out into the hydraulic circuit. Thus, even if a filter is disposed in an induction passage through which the working fluid is supplied from the reservoir into an inlet-and-outlet port (i.e., a bi-directional port) of the reversible pump, it is impossible to adequately remove or filter out contaminants/impurities from the hydraulic circuit owing to the unfiltered working fluid re-pumped out not through the filter.

In contrast, in the device of the embodiment, first and second directional control valve devices 100 and 200 are provided in respective pressure lines 21 and 22, each of which is provided for intercommunicating either one of the cylinder chambers and either one of the bi-directional ports of the pump. First pressure line 21 is connected at its upstream section 21a intercommunicating the first bi-directional port of pump P and first directional control valve device 100 to reservoir 7, whereas second pressure line 22 is connected at its upstream section 22a intercommunicating the second bi-directional port of pump P and second directional control valve device 200 to reservoir 7. Additionally, in the device of the embodiment, first filter 51 is disposed in first inflow line 28 intercommunicating first pressure line 21 and reservoir 7, whereas second filter 52 is disposed in second inflow line 29 intercommunicating second pressure line 22 and reservoir 7. Additionally, first inflow check valve 53 is disposed in the first inflow line 28 for permitting only a working fluid flow from reservoir 7 into first pressure line 21, whereas second inflow check valve 54 is disposed in the second inflow line 29 for permitting only a working fluid flow from reservoir 7 into second pressure line 22.

Regarding the first directional control valve side, under a first condition (P2>P1, see FIG. 5) where working fluid pressure is supplied into second pressure line 22 by means of pump P, that is, the fluid pressure P2 in second pressure line 22 is kept higher than the fluid pressure P1 in first pressure line 21 during operation of pump P, and also first directional control valve device 100 (exactly, the first pilot-operation directional control valve 101) receives the fluid pressure P2 supplied into second pressure line 22 as an external pilot pressure, first directional control valve device 100 operates to establish fluid communication between the downstream passage section 21b of first pressure line 21 and reservoir 7 and simultaneously to block fluid communication between upstream and downstream passage sections 21a-21b of first pressure line 21. Conversely under a second condition (P1>P2, see FIG. 4) where working fluid pressure is supplied into first pressure line 21 by means of pump P, that is, the fluid pressure P1 in first pressure line 21 is kept higher than the fluid pressure P2 in second pressure line 22 during operation of pump P, first directional control valve device 100 operates to establish fluid communication between upstream and downstream passage sections 21a-21b of first pressure line 21.

On the other hand, regarding the second directional control valve side, under the second condition (P1>P2, see FIG. 4) where working fluid pressure is supplied into first pressure line 21 by means of pump P, that is, the fluid pressure P1 in first pressure line 21 is kept higher than the fluid pressure P2 in second pressure line 22 during operation of pump P, and also second directional control valve device 200 (exactly, the second pilot-operation directional control valve 202) receives the fluid pressure P1 supplied into first pressure line 21 as an external pilot pressure, second directional control valve device 200 operates to establish fluid communication between the downstream passage section 22b of second pressure line 22 and reservoir 7 and simultaneously to block fluid communication between upstream and downstream passage sections 22a-22b of second pressure line 22. Conversely under the first condition (P2>P1, see FIG. 5), second directional control valve device 200 operates to establish fluid communication between upstream and downstream passage sections 22a-22b of second pressure line 22.

By virtue of the previously-noted construction and operation of each of first and second directional control valve devices 100 and 200, during the normal steering-assist mode (the normal power steering mode), in the power steering device of the embodiment shown in FIGS. 1-8, it is possible to return all of the working fluid, which is exhausted from the contracting cylinder chamber of cylinder chambers 61-62 of hydraulic power cylinder 6, to the reservoir 7. Additionally, it is possible to supply the filtered working fluid whose dust, dirt, or other contaminants/impurities are removed by means of either one of filters 51-52 into the expanding cylinder chamber of cylinder chambers 61-62. Therefore, it is possible to avoid the working fluid, exhausted from power cylinder 6, from being supplied into the pump without any filtering operation, thus enhancing the filtration performance for working fluid in the hydraulic system.

In addition to the above, in the device of the embodiment, working fluid, to be discharged into either one of first and second pressure lines 21-22, is pressurized by means of reversible pump P, and whereby it is possible to create a great pressure differential (P1-P2) between the fluid pressure P1 in first pressure line 21 and the fluid pressure P2 in second pressure line P2. Actually, each of first and second directional control valve devices 100 and 200 can operate with a high response by way of the great pressure differential (P1−P2). In other words, first and second directional control valve devices 100 and 200 can stably control the direction of working fluid flow by virtue of the great pressure differential (P1−P2).

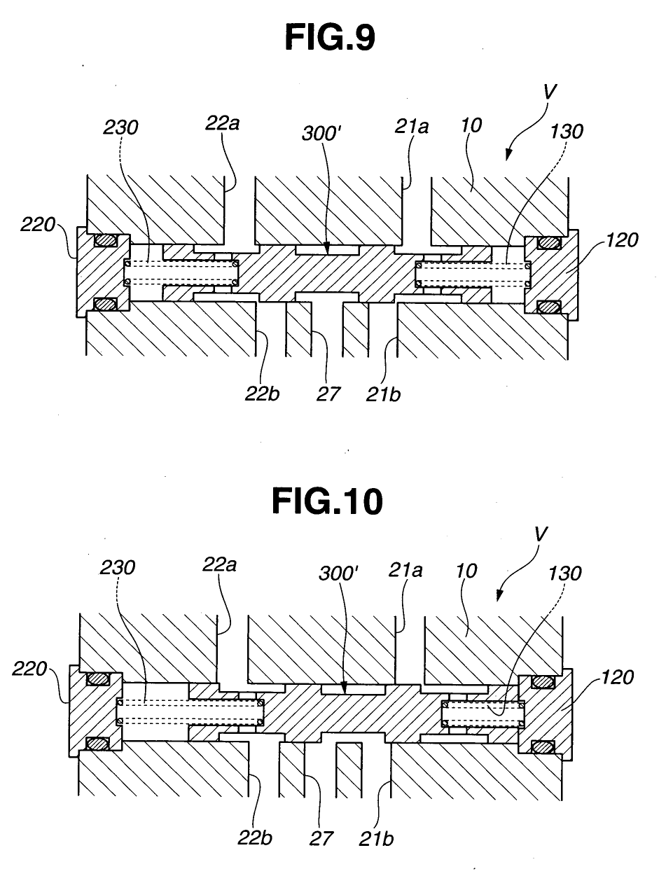

In the shown embodiment (in particular, in the device of the embodiment having a directional control valve configuration shown in FIGS. 2-3), first and second valve portions 110 and 210, and pressure-receiving valve 300, all included in first and second directional control valve devices 100 and 200, i.e., the integrated valve unit V, are separated from each other. That is, first and second valve portions 110 and 210, and pressure-receiving valve 300 are separate members detachably, axially slidably fitted to each other. In lieu thereof, as can be appreciated from the longitudinal cross section of a modified directional control valve unit shown in FIGS. 9-10, the first and second valve portions and the pressure-receiving valve may be formed as an integrated directional-control pressure-receiving valve member 300′ capable of controlling the direction of working fluid flow in the hydraulic circuit in response to the pressure differential (P1−P2) between first and second pressure lines 21-22 connected to the respective inlet-and- outlet ports (the respective bi-directional ports) of the reversible pump.

The entire contents of Japanese Patent Application No. 2005-226057 (filed Aug. 4, 2005) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A power steering device comprising:
a hydraulic power cylinder configured to assist a steering force of a steering mechanism linked to steered road wheels, the hydraulic power cylinder defining therein a first cylinder chamber and a second cylinder chamber;
a first pressure line connected to the first cylinder chamber;
a second pressure line connected to the second cylinder chamber;
a reversible pump having a first bi-directional port connected to the first pressure line and a second bi-directional port connected to the second pressure line, for selectively supplying working fluid pressure to either one of the first and second cylinder chambers;
a motor that drives the pump in a normal-rotational direction or in a reverse-rotational direction;
a motor control circuit that controls a driving state of the motor;
a first directional control valve disposed in the first pressure line;
a second directional control valve disposed in the second pressure line;
a reservoir that stores therein working fluid;
a first filter disposed in a first inflow line providing the working fluid from the reservoir to the second pressure line via the reversible pump, for filtering out contaminants from the working fluid;
a second filter disposed in a second inflow line providing the working fluid from the reservoir to the first pressure line via the reversible pump, for filtering out contaminants from the working fluid;
a first one-way valve disposed in the first inflow line, for permitting only a flow of the working fluid from the reservoir to the pump;
a second one-way valve disposed in the second inflow line, for permitting only a flow of the working fluid from the reservoir to the pump;
under a first condition where the first directional control valve receives the fluid pressure supplied into the second pressure line by the pump as a pilot pressure, the first directional control valve establishing fluid communication between the reservoir and a downstream passage section of the first pressure line extending from the first directional control valve to the first cylinder chamber, and blocking fluid communication between an upstream passage section extending from the first bi-directional port of the pump to the first directional control valve and the downstream passage section of the first pressure line;
under a second condition where the fluid pressure is supplied into the first pressure line by the pump, the first directional control valve establishing fluid communication between the upstream and downstream passage sections of the first pressure line;
under the second condition where the second directional control valve receives the fluid pressure supplied into the first pressure line by the pump as a pilot pressure, the second directional control valve establishing fluid communication between the reservoir and a downstream passage section of the second pressure line extending from the second directional control valve to the second cylinder chamber, and blocking fluid communication between an upstream passage section extending from the second bi-directional port of the pump to the second directional control valve and the downstream passage section of the second pressure line; and
under the first condition where the fluid pressure is supplied into the second pressure line by the pump, the second directional control valve establishing fluid communication between the upstream and downstream passage sections of the second pressure line.

2. The power steering device as claimed in claim 1, further comprising:
a first-pressure-line one-way valve disposed in the first pressure line and laid out in parallel with the first directional control valve, for permitting only a flow of the working fluid from the upstream passage section of the first pressure line to the downstream passage section of the first pressure line;
a preloading device that permanently forces the first-pressure-line one-way valve to remain closed;
a second-pressure-line one-way valve disposed in the second pressure line and laid out in parallel with the second directional control valve, for permitting only a flow of the working fluid from the upstream passage section of the second pressure line to the downstream passage section of the second pressure line; and
a preloading device that permanently forces the second-pressure-line one-way valve to remain closed.

3. The power steering device as claimed in claim 1, further comprising:
a pressure-receiving valve operated responsively to a pressure differential between the fluid pressure in the first pressure line and the fluid pressure in the second pressure line,
wherein the first directional control valve comprises a first valve portion having a first axial through hole, and the second directional control valve comprises a second valve portion having a second axial through hole, and
wherein both axial ends of the pressure-receiving valve are slidably fitted into the respective axial through holes of the first and second valve portions, a first axial end face of the pressure-receiving valve receives the fluid pressure in the first pressure line, and a second axial end face of the pressure-receiving valve receives the fluid pressure in the second pressure line.

4. The power steering device as claimed in claim 3, wherein:
the pressure-receiving valve operates the second directional control valve by receiving the fluid pressure in the first pressure line as the pilot pressure; and
the pressure-receiving valve operates the first directional control valve by receiving the fluid pressure in the second pressure line as the pilot pressure.

5. The power steering device as claimed in claim 3, wherein:
the fluid pressure in the first pressure line is supplied via the first axial through hole to the pressure-receiving valve; and
the fluid pressure in the second pressure line is supplied via the second axial through hole to the pressure-receiving valve.

6. The power steering device as claimed in claim 3, wherein:
when the motor is conditioned in a stopped state, the first directional control valve blocks fluid communication between the first pressure line and the reservoir, and the second directional control valve blocks fluid communication between the second pressure line and the reservoir.

7. The power steering device as claimed in claim 1, wherein:
the first and second directional control valves are coaxially laid out with respect to a common axis.

8. The power steering device as claimed in claim 7, further comprising:
a preloading device that permanently forces the first directional control valve in a direction that fluid communication between the upstream and downstream passage sections of the first pressure line is established; and
a preloading device that permanently forces the second directional control valve in a direction that fluid communication between the upstream and downstream passage sections of the second pressure line is established.

9. The power steering device as claimed in claim 1, wherein:
the first filter is disposed in a portion of the first inflow line in such a manner as to hermetically cover a first suction port, opening in the reservoir and connecting to the first inflow line, through which the working fluid is drawn from the reservoir into the pump; and
the second filter is disposed in a portion of the second inflow line in such a manner as to hermetically cover a second suction port, opening in the reservoir and connecting to the second inflow line, through which the working fluid is drawn from the reservoir into the pump.

10. The power steering device as claimed in claim 1, further comprising:
a first communicating line disposed between the downstream passage section of the first pressure line and the downstream passage section of the second pressure line for intercommunicating the downstream passage sections;
a second communicating line disposed between the downstream passage section of the first pressure line and the downstream passage section of the second pressure line for intercommunicating the downstream passage sections, and laid out in parallel with the first communicating line;
an intercommunication line that intercommunicates a first joined portion provided substantially at a midpoint of the first communicating line and a second joined portion provided substantially at a midpoint of the second communicating line;
a third check valve disposed in a portion of the first communicating line extending from the first joined portion to the downstream passage section of the second pressure line, for permitting only a flow of the working fluid from the downstream passage section of the second pressure line to the first joined portion;
a fourth check valve disposed in a portion of the first communicating line extending from the first joined portion to the downstream passage section of the first pressure line, for permitting only a flow of the working fluid from the downstream passage section of the first pressure line to the first joined portion;
a fifth check valve disposed in a portion of the second communicating line extending from the second joined portion to the downstream passage section of the second pressure line, for permitting only a flow of the working fluid from the second joined portion to the downstream passage section of the second pressure line;
a sixth check valve disposed in a portion of the second communicating line extending from the second joined portion to the downstream passage section of the first pressure line, for permitting only a flow of the working fluid from the second joined portion to the downstream passage section of the first pressure line; and
a solenoid valve disposed in the intercommunication line for switching between fluid-communication and cutoff states of the intercommunication line.

11. A power steering device comprising:
a hydraulic power cylinder configured to assist a steering force of a steering mechanism linked to steered road wheels, the hydraulic power cylinder defining therein a first cylinder chamber and a second cylinder chamber;
a first pressure line connected to the first cylinder chamber;
a second pressure line connected to the second cylinder chamber;
a reversible pump having a first bi-directional port connected to the first pressure line and a second bi-directional port connected to the second pressure line, for selectively supplying working fluid pressure to either one of the first and second cylinder chambers;
a motor that drives the pump in a normal-rotational direction or in a reverse-rotational direction;
a motor control circuit that controls a driving state of the motor;
a reservoir that stores therein working fluid;
a first filter disposed in a first inflow line providing the working fluid from the reservoir to the second pressure line via the reversible pump, for filtering out contaminants from the working fluid;
a second filter disposed in a second inflow line providing the working fluid from the reservoir to the first pressure line via the reversible pump, for filtering out contaminants from the working fluid;
a first one-way valve disposed in the first inflow line, for permitting only a flow of the working fluid from the reservoir to the pump;
a second one-way valve disposed in the second inflow line, for permitting only a flow of the working fluid from the reservoir to the pump;
a first valve portion disposed in the first pressure line for receiving the fluid pressure in the first pressure line;
a second valve portion disposed in the second pressure line for receiving the fluid pressure in the second pressure line;
a pressure-receiving valve provided between the first and second valve portions, for operating the second valve portion by the fluid pressure in the first pressure line and for operating the first valve portion by the fluid pressure in the second pressure line;
the pressure-receiving valve being responsive to the fluid pressure in the second pressure line for bringing the first valve portion to an operative state and for establishing fluid communication between the reservoir and the first cylinder chamber via the first valve portion; and
the pressure-receiving valve being responsive to the fluid pressure in the first pressure line for bringing the second valve portion to an operative state and for establishing fluid communication between the reservoir and the second cylinder chamber via the second valve portion.

12. The power steering device as claimed in claim 11, wherein:
the first valve portion has a first axial through hole;
the second valve portion has a second axial through hole;
the fluid pressure in the first pressure line is supplied via the first axial through hole to the pressure-receiving valve; and
the fluid pressure in the second pressure line is supplied via the second axial through hole to the pressure-receiving valve.

13. The power steering device as claimed in claim 11, wherein:
when the motor is conditioned in a stopped state, the first valve portion blocks fluid communication between the first pressure line and the reservoir, and the second valve portion blocks fluid communication between the second pressure line and the reservoir.

14. The power steering device as claimed in claim 11, wherein:
the first and second valve portions are coaxially laid out with respect to a common axis.

15. The power steering device as claimed in claim 14, further comprising:
a preloading device that permanently forces the first valve portion in a direction that fluid communication between the upstream and downstream passage sections of the first pressure line is established; and
a preloading device that permanently forces the second valve portion in a direction that fluid communication between the upstream and downstream passage sections of the second pressure line is established.

16. A method of controlling a power steering device comprising the steps of:
selectively supplying working fluid pressure produced by a reversible pump via a first pressure line and a second pressure line to either one of a first cylinder chamber and a second cylinder chamber defined in a hydraulic power cylinder configured to assist a steering force of a steering mechanism linked to steered road wheels, the first pressure line being connected to the first cylinder chamber and the second pressure line being connected to the second cylinder chamber;
exhausting working fluid from the first cylinder chamber into a reservoir by establishing fluid communication between the first cylinder chamber and the reservoir via a first directional control valve disposed in the first pressure line, when the fluid pressure supplied into the second pressure line acts on the first directional control valve;
exhausting working fluid from the second cylinder chamber into the reservoir by establishing fluid communication between the second cylinder chamber and the reservoir via a second directional control valve disposed in the second pressure line, when the fluid pressure supplied into the first pressure line acts on the second directional control valve; and
supplying the working fluid from the reservoir into a negative-pressure line of the first and second pressure lines, when the fluid pressure in either one of the first and second pressure lines becomes a negative pressure.

17. The method as claimed in claim 16, further comprising:
providing a pressure-receiving valve operated responsively to a pressure differential between the fluid pressure in the first pressure line and the fluid pressure in the second pressure line,
wherein the first directional control valve comprises a first valve portion having a first axial through hole, and the second directional control valve comprises a second valve portion having a second axial through hole, and
wherein both axial ends of the pressure-receiving valve are slidably fitted into the respective axial through holes of the first and second valve portions, a first axial end face of the pressure-receiving valve receives the fluid pressure in the first pressure line, and a second axial end face of the pressure-receiving valve receives the fluid pressure in the second pressure line.

18. The method as claimed in claim 17, wherein:
the pressure-receiving valve operates the second directional control valve by receiving the fluid pressure in the first pressure line as a pilot pressure; and
the pressure-receiving valve operates the first directional control valve by receiving the fluid pressure in the second pressure line as a pilot pressure.

19. The method as claimed in claim 16, further comprising:
shifting a solenoid valve, which is switchable between fluid-communication and cutoff states of the first and second pressure lines and disposed in a communicating circuit intercommunicating the first and second pressure lines, to a solenoid-valve open state, when a failure in the reversible pump occurs.

20. The method as claimed in claim 19, wherein:
the solenoid valve is a normally-open solenoid-actuated directional control valve; and
the solenoid valve is shifted to the valve open state by de-energizing a solenoid of the solenoid valve when the failure in the reversible pump occurs.

21. A power steering device comprising:
a hydraulic power cylinder configured to assist a steering force of a steering mechanism linked to steered road wheels, the hydraulic power cylinder defining therein a first cylinder chamber and a second cylinder chamber;
a first pressure line connected to the first cylinder chamber;
a second pressure line connected to the second cylinder chamber;
a reversible pump having a first bi-directional port connected to the first pressure line and a second bi-directional port connected to the second pressure line, for selectively supplying working fluid pressure to either one of the first and second cylinder chambers;
a driving means for driving the pump in a normal-rotational direction or in a reverse-rotational direction;
a first directional control means disposed in the first pressure line;
a second directional control means disposed in the second pressure line;
a reservoir that stores therein working fluid;
a first filter disposed in a first inflow line providing the working fluid from the reservoir to the second pressure line via the reversible pump, for filtering out contaminants from the working fluid;
a second filter disposed in a second inflow line providing the working fluid from the reservoir to the first pressure line via the reversible pump, for filtering out contaminants from the working fluid;
a first one-way valve disposed in the first inflow line, for permitting only a flow of the working fluid from the reservoir to the pump;
a second one-way valve disposed in the second inflow line, for permitting only a flow of the working fluid from the reservoir to the pump;
under a first condition where the first directional control means receives the fluid pressure supplied into the second pressure line by the pump as a pilot pressure, the first directional control means establishing fluid communication between the reservoir and a downstream passage section of the first pressure line extending from the first directional control means to the first cylinder chamber, and blocking fluid communication between an upstream passage section extending from the first bi-directional port of the pump to the first directional control means and the downstream passage section of the first pressure line;
under a second condition where the fluid pressure is supplied into the first pressure line by the pump, the first directional control means establishing fluid communication between the upstream and downstream passage sections of the first pressure line;
under the second condition where the second directional control means receives the fluid pressure supplied into the first pressure line by the pump as a pilot pressure, the second directional control means establishing fluid communication between the reservoir and a downstream passage section of the second pressure line extending from the second directional control means to the second cylinder chamber, and blocking fluid communication between an upstream passage section extending from the second bi- directional port of the pump to the second directional control means and the downstream passage section of the second pressure line; and
under the first condition where the fluid pressure is supplied into the second pressure line by the pump, the second directional control means establishing fluid communication between the upstream and downstream passage sections of the second pressure line.
